(19) United States
(12) Patent Application Publication
(10) Pub. No.: US 2019/0379043 A1
(43) Pub. Date: Dec. 12, 2019

(54) TRANSITION METAL COMPOSITE HYDROXIDE AND METHOD FOR PRODUCING THE SAME, POSITIVE ELECTRODE ACTIVE MATERIAL FOR A NON-AQUEOUS ELECTROLYTE SECONDARY BATTERY AND METHOD FOR PRODUCING THE SAME, AND NON-AQUEOUS ELECTROLYTE SECONDARY BATTERY

(71) Applicant: SUMITOMO METAL MINING CO., LTD., Tokyo (JP)

(72) Inventors: Takahiro TOMA, EHIME (JP); Taira AIDA, EHIME (JP); Tetsufumi KOMUKAI, EHIME (JP)

(73) Assignee: SUMITOMO METAL MINING CO., LTD., Tokyo (JP)

(21) Appl. No.: 16/463,703

(22) PCT Filed: Nov. 21, 2017
(86) PCT No.: PCT/JP2017/041850

§ 371 Date: May 23, 2019

(30) Foreign Application Priority Data
Nov. 25, 2016 (JP) 2016-229558

(51) Int. Cl. H01M 4/505; H01M 4/525; C01G 53/04; C01G 53/00

(52) U.S. Cl. CPC H01M 4/505; H01M 4/525; H01M 2004/021; C01G 53/66; C01G 53/04

(57) ABSTRACT

A positive electrode active material and its precursor capable of further improving output characteristics while maintaining capacity characteristics and cycle characteristics of a positive electrode active material having the solid structure is provided. A nucleation step and a particle growth step are clearly separated, and in the early period and middle period of the particle growth step which is 70% to 90% of time from the initiation of the particle growth step, the non-oxidizing atmosphere is maintained, and in the latter period of the particle growth step, the non-oxidizing atmosphere is switched to the oxidizing atmosphere, and then the oxidizing atmosphere is switched to the non-oxidizing atmosphere again so as to obtain a transition metal composite hydroxide comprising secondary particles formed by aggregates of plate-shaped primary particles and having a low-density layer formed from the aggregates of the fine primary particles having a smaller particle size than the plate-shaped primary particles near the surface of the secondary particles. The positive electrode active material obtained by using the transition metal composite hydroxide as the precursor comprising secondary particles formed by aggregates of a plurality of primary particles and its tap density is 1.5 g/cm³ or more, and the surface roughness index which is a value in which the measured specific surface area of the secondary particles is divided by the geometric surface area of the secondary particles when the secondary particles is assumed to be true sphere is within a range of 3.6 to 10.

### TECHNICAL FIELD

The present invention relates to a transition metal composite hydroxide and a method for producing the same, a positive electrode active material for a non-aqueous electrolyte secondary battery using this transition metal composite hydroxide as a precursor and a method for producing the same, further relates to a non-aqueous electrolyte secondary battery using this positive electrode active material for a non-aqueous electrolyte secondary battery as a positive electrode material.

### RELATED ART

In recent years, with the widespread use of mobile electronic devices such as mobile phones, laptop type personal computers, and the like, development of a small and light non-aqueous electrolyte secondary battery having high energy density is strongly desired. Development of a high-output secondary battery as a power source for electric vehicles such as hybrid electric vehicles, plug-in hybrid electric vehicles, battery-powered electric vehicles and the like is also strongly desired.

As a secondary battery satisfying such a requirement, there is a lithium ion secondary battery that is one type of non-aqueous electrolyte secondary battery. This lithium ion secondary battery comprises a negative electrode, a positive electrode, a non-aqueous electrolyte, and the like, and an active material capable of insertion/de-insertion of lithium is used as a material of the negative electrode and the positive electrode.

Currently, the research and development is actively performed for a lithium-ion secondary battery in which a lithium transition metal-containing composite oxide having a layered rock-salt type or spinel type crystal structure is used as the positive electrode material, which is capable of obtaining a high 4 volt class voltage and thus has a high energy density, and the practical use is partially advanced.

As the positive electrode active material for the non-aqueous electrolyte secondary battery which is the positive electrode material of the lithium ion secondary battery, lithium transition metal-containing composite oxides such as lithium cobalt composite oxide (LiCoO₂) which are relatively easy to synthesize, lithium nickel composite oxide (LiNiO₂) using nickel that is cheaper than cobalt, lithium nickel cobalt manganese composite oxide (LiNi_{1/3}Co_{1/3}Mn_{1/3}O₂), lithium manganese composite oxide (LiMn₂O₄) using manganese, lithium nickel manganese composite oxide (LiNi_{0.5}Mn_{0.5}O₂), and the like have been proposed.

Incidentally, in order to obtain a lithium ion secondary battery having excellent cycling characteristics and output characteristics, it is necessary that the positive electrode active material for a non-aqueous electrolyte secondary battery be formed from particles having a small particle size and narrow particle size distribution. This is because particles having a small particle size have a large specific surface area and not only can these particles sufficiently secure a reaction area with an electrolytic solution, but can also be used to make the positive electrode thin, and by shortening the moving distance between the positive electrode and the negative electrode, it is possible to reduce the positive electrode resistance. In addition, particles having a narrow particle size distribution are such that the voltage applied to each particle in the electrode is substantially constant, so it is possible to suppress a reduction in battery capacity due to selective deterioration of fine particles.

For example, JP2012-246199 (A), JP2013-147416 (A), and WO2012/131881 disclose a method for manufacturing a transition metal composite hydroxide formed from secondary particles having a small particle size and a narrow particle size distribution by clearly separating a crystallization reaction into two steps, namely a nucleation step where nucleation is mainly performed, and a particle growth step where particle growth is mainly performed. In this method, by suitably adjusting the pH value and the reaction atmosphere in the nucleation step and the particle growth step, a transition metal composite hydroxide having a low-density center portion formed from fine primary particles only and a high density outer-shell portion formed from plate-shaped or needle-shaped primary particles only, are obtained.

A positive electrode active material for a non-aqueous electrolyte secondary battery obtained by using this transition metal composite hydroxide as a precursor has a small particle size and a narrow particle size distribution, and has a hollow structure with an outer-shell portion and a space portion located inside of the outer-shell portion. Therefore, in secondary batteries using these positive electrode active materials for a non-aqueous electrolyte secondary battery, it is considered that the battery capacity, output characteristics, and cycle characteristics may be simultaneously improved.

### RELATED-ART DOCUMENT

### Patent Literature

Patent Literature 1: JP 2012-246199 (A)
Patent Literature 1: JP 2013-147416 (A)
Patent Literature 1: JP 2011-119092 (A)
Patent Literature 1: WO2012/131881

### SUMMARY OF INVENTION

### Problems to be Solved by the Invention

On the premise of application to a power source of an electric vehicle or the like, further improvement of output characteristics required for a positive electrode active material for a non-aqueous electrolyte secondary battery without impairing the battery capacity and cycle characteristics is desired, and in order for that, it is necessary to further reduce the positive electrode resistance in the positive electrode active material for a non-aqueous electrolyte secondary battery.

However, in comparison with a positive electrode active material having a solid structure, a positive electrode active material for a non-aqueous electrolyte secondary battery having a hollow structure with the outer-shell portion and the space portion located inside of the outer-shell portion is able to reduce the positive electrode resistance, but the total amount of the electrochemical reaction per volume becomes small, so that it is disadvantageous from the viewpoint of improving the volume energy density (battery capacity per unit volume).

In consideration of the problems described above, an object of the present invention is to provide a positive electrode active material for a non-aqueous electrolyte secondary battery and a transition metal composite hydroxide as a precursor thereof having a structure that can improve the output characteristics thereof without impairing the battery capacity and the cycle characteristics. Moreover, another object of the present invention is to provide a method for efficiently producing on an industrial scale such a positive electrode active material and a transition metal composite hydroxide.

### Means for Solving Problems

The first aspect of the present invention relates to a transition metal composite hydroxide that is used as a precursor of positive electrode active material for a non-aqueous electrolyte secondary battery. Particularly, the transition metal composite hydroxide of the present invention is formed from secondary particles constructed by aggregates of plate-shaped primary particles, and comprises at least one layer of low-density layer, which is constructed by aggregates of fine primary particles having a particle size smaller than the plate-shaped primary particles, and is located within a range of 30% from the surface of the secondary particles with respect to the particle size of the secondary particles, and it is characterized in that the average ratio of the thickness of the at least one layer of low-density layer with respect to the particle size of the secondary particles is within a range of 3% to 15%. When the low-density layer comprises two or more layers, the average ratio of the total thickness of the low-density layers with respect to the particle size of the secondary particles is within a range of 3% to 15%.

More particularly, the transition metal composite hydroxide of the present invention comprises a main portion which is constructed by the plate-shaped primary particles, a low-density layer which is formed outside the main portion and is constructed by the fine primary particles, and an outer-shell portion which is formed outside the low-density layer and is constructed by the plate-shaped primary particles. Alternatively, the transition metal composite hydroxide of the present invention comprises a main portion which is constructed by the plate-shaped primary particles, a low-density layer which is formed outside the main portion and is constructed by the fine primary particles, a high density layer which is formed outside the first low-density layer and is constructed by the plate-shaped primary particles, a second low-density layer which is formed outside the high density layer and is constructed by the fine primary particles, and an outer-shell portion which is formed outside the second low-density layer and is constructed by the plate-shaped primary particles.

The average ratio of the outer diameter of the main portion with respect to the particle size of the secondary particles is within a range of 65% to 95%, and the average ratio of the thickness of the outer-shell portion or the total thickness of the outer-shell portion and the high density layer with respect to the particle size of the secondary particles is preferably within a range of 2% to 15%.

The average particle size of the plate-shaped primary particles is within 0.3 μm to 3 μm, and the average particle size of the fine primary particles is preferably within a range of 0.01 μm to 0.3 μm.

The average particle size of the secondary particles is within a range of 1 μm to 15 μm, and the value of [(d90−d10)/average particle size], which is an index that represents the spread of the particle size distribution of the secondary particles, is preferably 0.65 or less.

The transition metal composite hydroxide of the present invention is not necessarily limited by its composition, but the transition metal composite hydroxide of the present invention preferably has a composition that is represented by a general formula (A): NiₓMn_{y}Co_{z}Mₜ (OH)₂₊ₐ, where x+y+z+t=1, 0.3≤x≤0.95, 0.05≤y≤0.55, 0≤z≤0.4, 0≤t≤0.1, 0≤a≤0.5, and M is one or more additional element selected from Mg, Ca, Al, Ti, V Cr, Zr, Nb, Mo, Hf, Ta, and W.

In this case, the additional element M can exist in a state where the additional element M is uniformly distributed inside the transition metal composite hydroxide, and/or a state where a surface of the transition metal composite hydroxide is coated by a compound that includes the additional element M.

The second aspect of the present invention relates to a method for manufacturing a transition metal composite hydroxide which is a precursor of the positive electrode active material for a non-aqueous electrolyte secondary battery by mixing a raw material aqueous solution including at least a transition metal element and an aqueous solution including an ammonium ion donor to form a reaction aqueous solution, and performing a crystallization reaction.

The method for manufacturing the transition metal composite hydroxide of the present invention comprises:

a nucleation step in which nucleation is performed in a non-oxidizing atmosphere having an oxygen concentration of 5% by volume or less in which the pH value at a standard liquid temperature of 25° C. of the reaction aqueous solution is adjusted to be within a range of 12.0 to 14.0,

a particle growth step in which the pH value at a standard liquid temperature 25° C. of the reaction aqueous solution including the nuclei obtained in the nucleation step is adjusted to be lower than the pH value of the nucleation step and to be within a range of 10.5 to 12.0 to cause to grow the nuclei.

Especially, in the method for manufacturing the transition metal composite hydroxide of the present invention, it is characterized in that atmosphere control is performed such that, in the early period and middle period of the particle growth step which is 70% to 90% of time from the initiation of the particle growth step with respect to the entire period of the particle growth step, the non-oxidizing atmosphere is maintained, and in the latter period of the particle growth step, the non-oxidizing atmosphere is switched to the oxidizing atmosphere having an oxygen concentration of more than 5% by volume, and then the oxidizing atmosphere is switched to the non-oxidizing atmosphere again.

It is preferable that, in the latter period of the particle growth step, after 0.5% to 20% of time with respect to the entire particle growth step passed from the point of switching the non-oxidizing atmosphere to the oxidizing atmosphere, the oxidizing atmosphere is switched to the non-oxidizing atmosphere again, and the non-oxidizing atmosphere is maintained from the point of switching the atmosphere again to the termination of the particle growth step, that is for a range of 3% to 20% of time with respect to the entire particle growth step.

In the method for manufacturing the transition metal composite hydroxide of the present invention as well, it is not necessarily limited by a composition of the transition metal composite hydroxide, but it is preferable that the composition of the transition metal composite hydroxide is represented by a general formula (A): NiₓMn_{y}Co_{z}Mₜ (OH)₂₊ₐ, where x+y+z+t=1, 0.3≤x≤0.95, 0.05≤y≤0.55, 0≤z≤0.4, 0≤t≤0.1, 0≤a≤0.5, and M is one or more additional element selected from Mg, Ca, Al, Ti, V, Cr, Zr, Nb, Mo, Hf, Ta, and W.

Incidentally, after the particle growth step, a coating step may be provided for coating the surface of the transition metal composite hydroxide with a compound that includes the additional element M.

The third aspect of the present invention relates to a positive electrode active material for a non-aqueous electrolyte secondary battery that comprises a lithium transition metal-containing composite oxide that includes secondary particles formed from aggregates of a plurality of primary particles, and that is used as a positive electrode material of the non-aqueous electrolyte secondary battery.

Particularly, the positive electrode active material for a non-aqueous electrolyte secondary battery of the present invention is characterized in that the tap density is 1.5 g/cm³ or more, and the surface roughness index which is a value in which the measured specific surface area of the secondary particles is divided by the geometric surface area of the secondary particles when the secondary particles is assumed to be true sphere is within a range of 3.6 to 10.

The average particle size of the secondary particles is within a range of 1 μm to 15 μm, and the value of [(d90−d10)/average particle size], which is an index indicating the spread of the particle size distribution of the secondary particles, is preferably 0.70 or less.

The positive electrode active material for a non-aqueous electrolyte secondary battery of the present invention is not necessarily limited by its composition neither, but the positive electrode active material for a non-aqueous electrolyte secondary battery of the present invention preferably comprises a hexagonal lithium nickel manganese composite oxide that is represented by a general formula (B): Li₁₊ᵤNiₓMn_{y}Co_{z}MₜO₂, where −0.05≤u≤0.50, x+y+z+t=1, 0.3≤x≤0.95, 0.05≤y≤0.55, 0≤z≤0.4, 0≤t≤0.1, and M is one or more additional element selected from Mg, Ca, Al, Ti, V Cr, Zr, Nb, Mo, Hf, Ta, and W.

The fourth aspect of the present invention relates to a method for manufacturing a positive electrode active material for a non-aqueous electrolyte secondary battery comprising a mixing step where a precursor and a lithium compound is mixed to obtain a lithium mixture, and a firing step where the lithium mixture is fired in an oxidizing atmosphere at a temperature range of 650° C. to 1000° C. to obtain a positive electrode active material for a non-aqueous electrolyte secondary battery that comprises a lithium transition metal-containing composite oxide. Especially, in the method for manufacturing the positive electrode active material for a non-aqueous electrolyte secondary battery of the present invention, it is characterized in using the transition metal composite hydroxide of the present invention or heat-treated particles obtained by heat-treating the transition metal composite hydroxide as the precursor.

In the mixing step, it is preferable to adjust the mixing amount of the lithium compound is preferably adjusted so that the ratio of the number of atoms of Li that is included in the lithium mixture with respect to the sum of the number of atoms of metal elements other than Li is within a range of 0.95 to 1.5.

Moreover, it is further possible to provide a heat-treating step to heat-treat the transition metal composite hydroxide at a temperature range of 105° C. to 750° C. before the mixing step.

In the method for manufacturing the positive electrode active material for a non-aqueous electrolyte secondary battery of the present invention as well, it is not necessarily limited by the composition of the obtained positive electrode active material for a non-aqueous electrolyte secondary battery, but it is preferable that the composition of the lithium transition metal-containing composite oxide that constitutes the positive electrode active material for a non-aqueous electrolyte secondary battery is represented by a general formula (B): Li₁₊ᵤNiₓMn_{y}Co_{z}MₜO₂, where −0.05≤u≤0.50, x+y+z+t=1, 0.3≤x≤0.95, 0.05≤y≤0.55, 0≤z≤0.4, 0≤t≤0.1, and M is one or more additional element selected from Mg, Ca, Al, Ti, V, Cr, Zr, Nb, Mo, Hf, Ta, and W.

The fifth aspect of the present invention relates to a non-aqueous electrolyte secondary battery comprising a positive electrode, a negative electrode, a separator, and a non-aqueous electrolyte. Especially, in the non-aqueous electrolyte secondary battery of the present invention, it is characterized in that the above positive electrode active material for a non-aqueous electrolyte secondary battery of the present invention is used as the positive electrode material of the positive electrode.

### Effects of the Invention

According to the present invention, it is possible to provide a positive electrode active material for a non-aqueous electrolyte secondary battery that is able to further improve the output characteristics without impairing the battery capacity and cycle characteristics of the positive electrode active material having a solid structure when it is incorporated in a non-aqueous electrolyte secondary battery. Further, according to the present invention, it is possible to efficiently manufacture the positive electrode active material for a non-aqueous electrolyte secondary battery that contributes to the improvement of such battery characteristics and the transition metal composite hydroxide as its precursor on an industrial scale. Therefore, the present invention has extremely large industrial significance.

### BRIEF DESCRIPTION OF DRAWINGS

FIG. 1 is a cross-sectional view schematically illustrating the structure of a transition metal composite hydroxide of the present invention.

FIG. 2 is an FE-SEM image (5000× magnification rate) illustrating the surface of the positive electrode active material for a non-aqueous electrolyte secondary battery obtained in Example 1.

FIG. 3 is a FE-SEM image (5000× magnification rate) illustrating the surface of the positive electrode active material for a non-aqueous electrolyte secondary battery obtained in Comparative Example 1.

FIG. 4 is a schematic cross sectional view of a 2032 type coin battery used for battery evaluation.

FIG. 5 is a schematic explanatory diagram of an example of measurement of impedance evaluation and an equivalent circuit used for analysis.

### MODES FOR CARRYING OUT THE INVENTION

The inventors of the present invention diligently performed study in order to further improve the output characteristics of the positive electrode active material for a non-aqueous electrolyte secondary battery (hereinafter referred to as “positive electrode active material”) obtained based on conventional techniques such as described in WO 2004/181891 having a small particle size and narrow particle size distribution, and having a hollow structure with an outer-shell portion and a space portion located on the inner side of the outer shell portion.

The positive electrode active material having the hollow structure has a larger contact area with electrolyte due to the hollow structure in comparison with the positive electrode active material having the solid structure and therefore the effect of reducing the positive electrode resistance can be obtained, although there is a problem that the total amount of the electrochemical reaction per volume becomes smaller due to the hollow structure so that it is inferior to the positive electrode active material of the solid structure from the viewpoint of the volume energy density (battery capacity per unit volume).

The inventors of the present invention focused on the effect that the powder characteristics of the positive electrode active material gives to the positive electrode resistance and conducted extensive studies. As a result, they found that the output characteristics can be improved by increasing the surface roughness of each secondary particle by making the surface uneven while constructing the positive electrode active material with the solid structure, that is, by increasing the surface area of the secondary particles so as to increase the contact area with the electrolyte, reduce the positive electrode resistance of the battery and make the electrochemical reaction occur more easily.

Further, in order to obtain such structure of the positive electrode active material, it was found that by supplying an atmosphere gas with a diffusing pipe in the step for manufacturing the transition metal composite hydroxide as the precursor, and switching the reaction atmosphere from the non-oxidizing atmosphere and the oxidizing atmosphere in a short time without stopping the supply of the raw material aqueous solution, it is possible to provide a low-density layer that is formed from the aggregates of the fine primary particles near the surface of the secondary particles that are formed from the aggregates of the plate-shaped primary particles.

Further, it was found that by using the transition metal composite hydroxide having such a structure as a precursor, a positive electrode active material that is formed from secondary particles the surface of which has an uneven shape and thus has a large surface roughness, and by using the positive electrode active material having such a structure, it is possible to further improve the output characteristics without impairing the battery capacity and cycle characteristics of the positive electrode active material having the solid structure.

The present invention has been completed based on these findings.

1. Transition Metal Composite Hydroxide

(1-1) Structure of Transition Metal Composite Hydroxide

a) Structure of Secondary Particles

The structure of the transition metal composite hydroxide of the present invention (hereinafter referred to as “composite hydroxide”) is characterized in being constructed by secondary particles formed from aggregates of plate-shaped primary particles and comprising at least one layer of low-density layer that is formed from aggregates of fine primary particles having a smaller particle size than the plate-shaped primary particles, the low-density layer being located near the surface of the secondary particles.

In the composite hydroxide of the present invention, the low-density layer is located within a range of 30% from the surface of each of the secondary particles with respect to the particle size, preferably within a range of up to 25%, more preferably within a range of up to 20%. As the low-density layer exists in this range, it is possible to obtain an effect to increase the surface area by making the surface of the positive electrode active material that was obtained by firing this composite hydroxide uneven and increasing the surface roughness.

Regarding the low-density layer, it is inevitable that part of it is exposed to the surface of the secondary particles, but preferably, the low-density layer is entirely covered with an the outer-shell portion that is formed from plate-shaped primary particles.

The thickness of the low-density layer is controlled so as to be able to improve the characteristics of the surface in the positive electrode active material. In particular, the average ratio of the thickness of the low-density layer with respect to the particle size of the secondary particles of the composite hydroxide (hereinafter referred to as “low-density layer ratio to particle size”) is within a range of 3% to 15%. The low-density layer ratio to particle size is preferably within a range of 5% to 10%. By making the low-density layer ratio to particle size to be within such a range, in the positive electrode active material obtained by using the composite hydroxide as the precursor, it is possible to sufficiently secure the effect of increasing the surface area of the particle surfaces. When the low-density layer exists more than two layers, the average ratio with respect to the particle size of the secondary particles of the total thickness of all the low-density layers is within a range of 3% to 15%, preferably within a range of 5% to 10%.

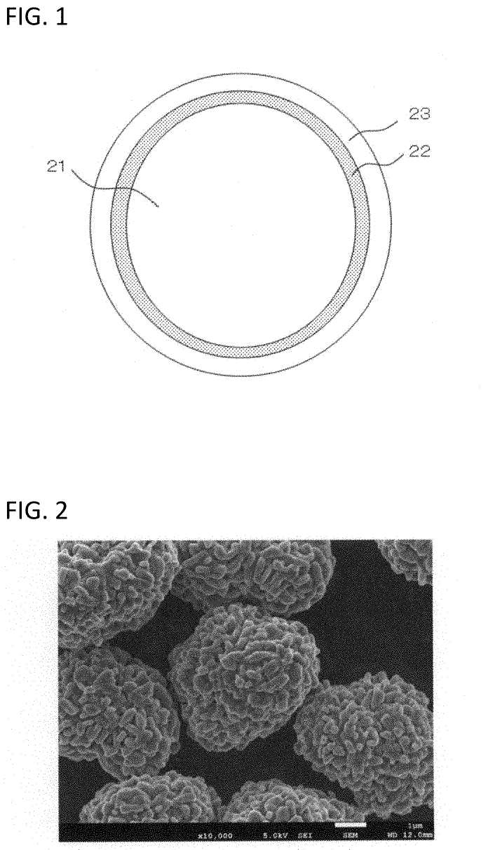

As a structure of a preferable aspect of the transition metal composite hydroxide of the present invention, as illustrated in FIG. 1, the structure comprises a main portion which is constructed by the plate-shaped primary particles 21, a low-density layer 22 that is formed outside the main portion and constructed by the fine primary particles, an outer-shell portion 23 that is formed outside the low-density layer and constructed by the plate-shaped primary particles. Alternatively, as a structure of the transition metal composite hydroxide of the present invention, it is possible to employ a structure comprising a main portion which is constructed by the plate-shaped primary particles, a low-density layer which is formed outside the main portion and is constructed by the fine primary particles, a high density layer which is formed outside the first low-density layer and is constructed by the plate-shaped primary particles, a second low-density layer which is formed outside the high density layer and is constructed by the fine primary particles, an outer-shell portion which is formed outside the second low-density layer and is constructed by the plate-shaped primary particles.

However, the present invention is not limited to such a structure. That is, the low-density layer does not necessarily cover the entire main portion of the secondary particles uniformly, and particles in which the low-density layer partially covers the main portion are also included. Further, in a case where a plurality of low-density layers exist, it is not necessary for these layers to form a clear laminated structure with a high density layer.

The average ratio of the outer diameter of the main portion with respect to the particle size of the secondary particles (hereinafter referred to as “main portion ratio to particle size”) is preferably within a range of 65% to 95%, more preferably within a range of 70% to 93%, further preferably within a range of 80% to 90%. By making the main portion ratio to particle size sufficiently large, in the obtained positive electrode active material, it is possible to realize secondary particles substantially having a solid structure, and it is possible to sufficiently secure the volume energy density (battery capacity per unit volume) by making the total amount of the electrochemical reaction per volume large. When the main portion ratio to particle size becomes smaller than 65%, in the obtained positive electrode active material, a probability in which secondary particles having such as a porous structure that is different from the solid structure may exist becomes high.

The thickness of the outer-shell portion, or the average ratio of the sum of the thickness of the outer-shell portion and the high density layer with respect to the particle size of the secondary particles (hereinafter referred to as “outer-shell portion ratio to particle size”) is preferably within a range of 2% to 15%, more preferably within a range of 5% to 10%. It is sufficient for the outer-shell portion to have a thickness to the extent so as to be able to maintain the structure of the transition metal composite hydroxide. When the outer-shell portion ratio to particle size becomes lower than 2%, the secondary particles cannot be maintained in the step of manufacturing the transition metal composite hydroxide or in the step of manufacturing the positive electrode active material so that there is a possibility that the particle distribution deteriorates. On the other hand, when the thickness of the outer-shell portion exceeds 15%, the structure of the outer-shell portion is maintained in the positive electrode active material and there is a high possibility that secondary particles having such as a porous structure that is different from the solid structure may exist.

In the structure where the low-density layers and the high density layer are laminated near the surface of the secondary particles, the average ratio of the thickness of the outer-shell portion with respect to the particle size of the secondary particles is 2% or more, and the thickness of the high density layer is arbitrary as long as the outer-shell portion ratio to particle size is within the above-mentioned range.

The main portion ratio to particle size, the low-density layer ratio to particle size, and the outer-shell portion ratio to particle size can be obtained by observing the cross section of the composite hydroxide with a scanning electron microscope (SEM) such as a field emission scanning electron microscope (FE-SEM) or the like. Specifically, in a field of view where the low-density layer can be distinguished, measure the maximum length between any two points on the outer edge of the secondary particles in the cross section of the secondary particles of the composite hydroxide and that value is set as the particle size of the composite hydroxide. Further, by observing the cross section of the secondary particles and measuring the outer diameter of the main portion, the thickness of the low-density layer and the thickness of the outer-shell portion in three or more arbitrary points with respect to one particle to obtain the average values.

The thickness of the low-density layer is set as the length between two points comprising an arbitrary point from the outer edge of the low-density layer in the cross section of the secondary particle of the composite hydroxide and a point on a boundary between the low-density layer and the main portion where the length from the arbitrary point becomes the shortest. By dividing the thickness of the low-density layer by the particle size of the composite hydroxide, the ratio of the thickness of the low-density layer with respect to the particle size of the composite hydroxide, that is, the low-density layer ratio to particle size is determined. By performing the same measurement to ten or more composite hydroxides to calculate its average value, it is possible to obtain the low-density layer ratio to particle size in the entire sample.

As necessary, it is possible to measure the outer diameter of the main portion, the thickness of the outer-shell portion, and the thickness of the low-density layer and the high-density layer when a laminate structure of them exists near the surface, in a way similar to that of the low-density layer regarding each structure.

b) Fine Primary Particles

In the composite hydroxide of the present invention, the fine primary particles that are the constituent elements of the low-density layer preferably have the average particle size of 0.01 μm to 0.3 μm, more preferably 0.1 μm to 0.3 μm. Here, when the average particle size of the fine primary particles is less than 0.01 μm, there may be a case where the thickness of the low-density layer cannot be obtained sufficiently. On the other hand, when the average particle size of the fine primary particles is larger than 0.3 μm, the density difference between a portion formed from the plate-shaped primary particles and the low-density layer becomes small and there may be a possibility that the surface of the positive electrode active material is not sufficiently uneven as a result of the particle surface of the composite hydroxide is fired and densified in the firing step when manufacturing the positive electrode active material.

The shape of such fine primary particles is preferably a needle shape. As the needle-shaped primary particles have a shape having a one-dimensional direction, they form a structure having a lot of gaps (i.e. a structure having a low-density) when the particles aggregate. Due to this, the density difference between the low-density layer and the portion formed from the plate-shaped primary particles can be sufficiently large.

Further, the average particle size of the fine primary particles can be obtained as follows by using a scanning electron microscope (SEM) to observe a portion where the particles are embedded after embedding the composite hydroxide to a resin or the like and by smoothing the portion by cross section polisher processing or the like. First, the maximum outer diameter of ten or more fine primary particles that exist on the cross section of one composite oxide is measured to obtain its average value, and this value is set to be the particle size of the fine primary particles in the composite hydroxide. Next, the same measurement of length and calculation is performed on ten or more composite hydroxides to obtain the particle size of their fine primary particles. Lastly, by averaging the particle sizes of the fine primary particles in these composite hydroxides, the average particle size of the fine primary particles in the entire sample can be obtained.

c) Plate-Shaped Primary Particles

The plate-shaped primary particles constituting the portion other than the low-density layer of each of the secondary particles of the composite hydroxide of the present invention, that is, the main portion which is a basic structure, and the outer-shell portion or the high density layer and the outer-shell portion, preferably has an average particle size of 0.3 μm to 3 μm, more preferably 0.4 μm to 1.5 μm, even more preferably 0.4 μm to 1.0 μm. Here, when the average particle size of the plate-shaped primary particles is less than 0.3 μm, volume shrinkage occurs at a low temperature as well in the firing step of manufacturing the positive electrode active material, and therefore the difference in the amount of volume shrinkage against the low-density layer becomes small, and the particle surface of the composite hydroxide is fired and densified, and as a result, there may be a case where the surface of the positive electrode active material is not sufficiently formed uneven. On the other hand, when the average particle size of the plate-shaped primary particles is larger than 3 μm, firing at a higher temperature is required in order to improve the crystallinity of the positive electrode active material in the firing step when manufacturing the positive electrode active material so that the sintering between the particles of the composite hydroxide proceeds and it becomes difficult to set the average particle size of the positive electrode active material and the particle size distribution within a predetermined range. The average particle size of the plate-shaped primary particles can be obtained in a way similar to that of the fine primary particles.

(1-2) Average Particle Size of Transition Metal Composite Hydroxide

The average particle size of the secondary particles that constitutes the composite hydroxide of the present invention is adjusted to 1 μm to 15 μm, preferably 3 μm to 12 μm, more preferably 3 μm to 10 μm. The average particle size of the positive electrode active material correlates to the average particle size of this composite hydroxide. Therefore, by setting, the average particle size of the composite hydroxide within such ranges, is becomes possible to make the average particle size of the positive electrode active material obtained by using this composite hydroxide as the precursor to be within a predetermined range.

Here, in the present invention, the average particle size of the composite hydroxide means the volume-based average particle diameter (MV), and it can be obtained from the volume integrated value that was measured with, for example, a laser light diffraction scattering type particle size analyzer.

(1-3) Particle Size Distribution of Transition Metal Composite Hydroxide

The composite hydroxide of the present invention is adjusted so that the value of [(d90−d10)/average particle size], which is an index indicating the spread of the particle size distribution, is 0.65 or less, preferably 0.55 or less, more preferably 0.50 or less.

The particle size distribution of the positive electrode active material is strongly affected by the composite hydroxide which is its precursor. Therefore, for example, when a composite hydroxide including a lot of fine particles and coarse particles as a precursor to manufacture a positive electrode active material, the positive electrode active material also includes a lot of fine particles and coarse particles so that it becomes impossible to sufficiently improve the output characteristics while maintaining high safety and cycle characteristics of the secondary battery using this positive electrode active material. Therefore, when the particle size distribution of the composite hydroxide which is its precursor is adjusted so that the value of [(d90−d10)/average particle size] becomes 0.65 or less, it becomes possible to narrow the particle size distribution of the positive electrode active material having this as a precursor and avoid problems related to the safety and cycle characteristics due to the selective deterioration of the fine particles. However, when manufacturing on an industrial scale is considered, manufacturing a powder state having an excessively small value of [(d90−d10)/average particle size] of the composite hydroxide is not realistic from the view point of yield, productivity, or manufacturing cost. Therefore, the lower limit of the value of [(d90−d10)/average particle size] is preferably about 0.25.

Here, d10 means the particle size at which the number of particles at each particle size of powder samples are accumulated from the side of smaller particle size, and the cumulative volume thereof is 10% of the total volume of all particles, and d90 means the particle size at which the cumulative volume becomes 90% of the total volume of all particles when the number of particles is accumulated by the same method. In the same way as finding the average particle size of the composite hydroxide, d10 and d90 can be obtained from the volume integrated value measured using a laser light diffraction scattering type particle size analyzer.

(1-4) Composition of Transition Metal Composite Hydroxide

The composite hydroxide of the present invention is characterized in its particle structure of the secondary particles, so that the composition of the composite hydroxide of the present invention is not specifically limited. However, it is preferable to be a composite hydroxide represented by a general formula (A): NiₓMn_{y}Co_{z}Mₜ (OH)₂₊ₐ, where x+y+z+t=1, 0.3≤x≤0.95, 0.05≤y≤0.55, 0≤z≤0.4, 0≤t≤0.1, 0≤a≤0.5, and M is one or more additional element selected from Mg, Ca, Al, Ti, V Cr, Zr, Nb, Mo, Hf, Ta, and W. By making such composite hydroxide to be a precursor, it is possible to easily obtain a positive electrode active material that is represented by a general formula (B): Li₁₊ᵤNiₓMn_{y}Co_{z}MₜO₂, where −0.05≤u≤0.50, where x+y+z+t=1, 0.3≤x≤0.95, 0.05≤y≤0.55, 0≤z≤0.4, 0≤t≤0.1, and M is one or more additional element selected from Mg, Ca, Al, Ti, V, Cr, Zr, Nb, Mo, Hf, Ta, and W and realize higher battery characteristics.

In such a composite hydroxide, the added element (M) can be uniformly dispersed in the composite hydroxide by crystalizing with a transition metal (nickel, cobalt and manganese) due to a crystallization reaction, but the outermost surface of the composite hydroxide may be covered with a composition mainly including the added element (M) after the crystallization reaction. Further, in the mixing step when manufacturing the positive electrode active material, it is also possible to mix a compound including the added element (M) together with the lithium compound to the composite hydroxide, and these methods may be used together as well. In a case of any of these methods, it is required to adjust the content of the composite hydroxide so as to eventually have a desired composition including a composition that is represented by a general formula (A).

Incidentally, in the complex hydroxide represented by the general formula (A), the composition ranges and the critical significance thereof of nickel, manganese, cobalt and the additional element M of the complex hydroxide are the same as the positive electrode active material represented by the general formula (B). Therefore, an explanation of these will be omitted here.

2. Method for Producing Transition Metal Composite Hydroxide

(2-1) Aqueous Solution Supply

In the method for producing a complex hydroxide of the present invention, a raw material aqueous solution including at least a transition metal, preferably nickel, nickel and manganese, or nickel, manganese and cobalt, and an aqueous solution including an ammonium ion donor are supplied to form a reaction aqueous solution, and while adjusting the pH value of the aqueous reaction solution to a predetermined range with a pH adjusting agent, a complex hydroxide is obtained by a crystallization reaction.

a) Raw Material Aqueous Solution

In the present invention, the ratio of the metal element included in the raw material aqueous solution is almost the same as the composition ratio of the composite hydroxide that will be obtained. Therefore, it is necessary that the content of each metal component of the raw aqueous solution be appropriately adjusted according to the composition of the desired composite hydroxide. For example, in the case of obtaining a composite hydroxide having the composition represented by the general formula (A), it is necessary to adjust the ratio of the metal elements in the aqueous solution to be Ni:Mn:Co:M=x:y:z; t, where, x+y+z+t=1, 0.3≤x≤0.95, 0.05≤y≤0.55, 0≤z≤0.4, 0≤t≤0.1. However, when the additional element M is introduced in a separate step as described above, the additional element M is not included in the raw material aqueous solution. Moreover, in the nucleation step and the particle growth step, it is also possible to change whether or not an additional element M is added, or it is possible to change the content ratio of the transition metals and the additional element M.

The transition metal compound for preparing the raw material aqueous solution is not particularly limited, however, from the aspect of ease of handling, it is preferable to use water-soluble nitrate, sulfate, hydrochloride, or the like, and from the aspect of raw material cost and preventing contamination of halogen components, it is particularly preferable to use a sulfate.

Moreover, in the case where an additional element M (M is one or more kind of additional element selected from among Mg, Ca, Al, Ti, V, Cr, Zr, Nb, Mo, Hf, Ta and W) is included in the composite hydroxide, preferably a water-soluble compound is similarly used as a compound for supplying the additional element M, and for example, magnesium sulfate, calcium sulfate, aluminum sulfate, titanium sulfate, ammonium peroxotitanate, potassium titanium oxalate, vanadium sulfate, ammonium vanadate, chromium sulfate, potassium chromate, zirconium sulfate, niobium oxalate, ammonium molybdate, hafnium sulfate, sodium tantalate, sodium tungstate, ammonium tungstate and the like can be suitably used.

The concentration of the raw material aqueous solution is determined based on the total material amount of the metal compound, and is preferably 1 mol/L to 2.6 mol/L, and more preferably 1.5 mol/L to 2.2 mol/L. When the concentration of the raw material aqueous solution is less than 1 mol/L, the amount of crystallization per volume of the reaction tank decreases, so productivity decreases. On the other hand, when the concentration of the mixed aqueous solution exceeds 2.6 mol/L, the saturation concentration at room temperature is exceeded, so crystals of the respective metal compounds may be reprecipitated and clog the piping and the like.

The above-described metal compound is not necessarily supplied to the reaction tank as a raw material aqueous solution. For example, in the case where a crystallization reaction is performed using a metal compound that reacts to form a compound other than a target compound upon mixing, it is preferable that the total concentrations of all metal compound aqueous solutions be adjusted and prepared individually so that the total concentration of the metal compound aqueous solutions are within the ranges described above, and may be supplied as an aqueous solutions of each metal compound into the reaction tank at specified ratios.

The supply amount of the raw material aqueous solution is preferably such that the concentration of the product in the reaction aqueous solution is preferably 30 g/L to 200 g/L, and more preferably 80 g/L to 150 g/L at the end point of the particle growth process. When the concentration of the product is less than 30 g/L, the aggregation of the primary particles may be insufficient in some cases. On the other hand, when the concentration of the product exceeds 200 g/L, stirring of the reaction aqueous solution is not sufficiently carried out in the reaction tank, and the aggregation conditions become nonuniform, so a bias in the particle growth may occur in some cases.

b) Alkaline Aqueous Solution

[O O O 1] The alkaline aqueous solution for adjusting the pH value in the reaction aqueous solution is not particularly limited, and a general aqueous alkali metal hydroxide aqueous solution such as sodium hydroxide or potassium hydroxide can be used. It should be noted that the alkali metal hydroxide can be directly added to the reaction aqueous solution in a solid state, however from the aspect of ease of pH control, it is preferable to add the alkali metal hydroxide as an aqueous solution. In this case, the concentration of the alkali metal hydroxide aqueous solution is preferably 20% by mass to 50% by mass, and more preferably 20% by mass to 30% by mass. By setting the concentration of the alkali metal aqueous solution within such a range, it is possible to prevent an increase in the local pH value due to the addition position in the reaction tank while suppressing the amount of solvent to be supplied to the reaction system, or in other words, the amount of water, so it is possible to efficiently obtain a composite hydroxide having a narrow particle size distribution.

The method of supplying the alkaline aqueous solution is not particularly limited as long as the pH value of the reaction aqueous solution does not locally increase and is kept within a specified range. For example, the alkaline aqueous solution may be supplied by a pump capable of flow rate control such as a metering pump while sufficiently stirring the reaction aqueous solution.

c) Aqueous Solution Including an Ammonium Ion Donor

The aqueous solution including an ammonium ion donor is not particularly limited as long as it is able to supply an ammonium ion in the raw material aqueous solution, and for example, ammonia water or aqueous solutions such as ammonium sulfate, ammonium chloride, ammonium bicarbonate or ammonium fluoride can be used.

In the case where ammonia water is used as the ammonium ion supplier, the concentration thereof is preferably 20% by mass to 30% by mass, and more preferably 22% by mass to 28% by mass. By setting the concentration of the ammonia water within such a range, it is possible to suppress the loss of ammonia from the reaction tank due to volatilization or the like to a minimum, and thus it is possible to improve production efficiency.

Incidentally, as with the alkali aqueous solution, the method of supplying the aqueous solution including the complexing agent can also be supplied by a pump capable of flow rate control.

(2-2) Crystallization Reaction

Especially, in the method for producing a composite hydroxide of the present invention, the crystallization reaction is clearly separated into two steps, a nucleation step in which nucleation is mainly performed and a particle growth step in which mainly particle growth is performed, and together with adjusting the conditions of the crystallization reaction in the respective steps, in the particle growth step, the reaction atmosphere, or in other words, the atmosphere in the reaction solution is appropriately switched between a non-oxidizing atmosphere and an oxidizing atmosphere while continuing the supply of the raw material aqueous solution. At the time of switching this atmosphere, an atmospheric gas, or in other words, an oxidizing gas or an inert gas is fed into the reaction aqueous solution, and by quickly switching the reaction atmosphere by causing direct contact between the gas and reaction aqueous solution, it is possible to efficiently obtain a composite hydroxide having the above-mentioned particle structure, that is, a particle structure in which the low-density layer and the outer-shell portion are laminated at the surface of the secondary particles, or a particle structure in which the first low-density layer and the second low-density layer are laminated with the high density layer and the outer-shell portion respectively, the above average particle size, and the above particle size distribution.

[Nucleation Step]

In the nucleation step, first, a transition metal compound that will become the raw material of the composite hydroxide is dissolved in water to prepare a raw material aqueous solution. In addition, an alkaline aqueous solution and an aqueous solution including a complexing agent are supplied into the reaction tank to prepare a pre-reaction aqueous solution in which the pH value at a standard liquid temperature of 25° C. is 12.0 to 14.0. Here, the pH value of the pre-reaction aqueous solution can be measured with a pH meter.

Next, the raw material aqueous solution is supplied while stirring this reaction aqueous solution. As a result, in the reaction tank, the reaction aqueous solution of the nucleation step is formed. The pH value of this reaction aqueous solution is within the above-described range, so in the nucleation step, nuclei hardly grow and nucleation occurs preferentially. Incidentally, in the nucleation step, the pH value and the concentration of ammonium ion of the reaction aqueous solution changes as nuclei are formed, so by timely supplying an alkaline aqueous solution and ammonia aqueous solution, the pH value of the aqueous reaction solution is controlled so as to be maintained within a range of 12.0 to 14.0 at a standard liquid temperature of 25° C., and the concentration of ammonium ion is controlled so as to be maintained within a range of 3 g/L to 25 g/L.

In addition, during the nucleation step, by causing an inert gas to flow through the reaction aqueous solution in the reaction tank, the reaction atmosphere in the reaction tank is adjusted to an non-oxidizing atmosphere having an oxygen concentration of 5% by volume or less. Here, the method of supplying the inert gas to the reaction aqueous solution in the reaction tank, may be either a method of supplying the oxidizing gas to a space in the reaction tank that is in contact with the reaction aqueous solution, or a method of directly supplying the oxidizing gas into the reaction aqueous solution using a diffusing pipe or the like. However, it is sufficient to adjust the reaction atmosphere in the nucleation step by supplying an inert gas into the reaction tank.

In the nucleation step, by supplying an aqueous solution including a raw material aqueous solution, an alkaline aqueous solution, and an ammonium ion donor to the reaction aqueous solution, the nucleus formation reaction is continuously being made to continue, and at the point where there is a specified amount of nuclei formed in the reaction aqueous solution, the nucleation step is terminated.

In this case, the amount of nuclei formed can be determined from the amount of the metal compound included in the raw material aqueous solution supplied to the reaction aqueous solution. The amount of nuclei formed in the nucleation step is not particularly limited, however, in order to obtain a composite hydroxide having a narrow particle size distribution, it is preferable that with respect to the amount of metal elements in the metal compound included in the raw material aqueous solution supplied through the nucleation step and the particle growth step, it be 0.1 atomic % to 2 atomic %, and more preferably 0.1 atomic % to 1.5 atomic %. Note that the reaction time in the nucleation step is usually about 1 minute to 5 minutes.

[Particle Growth Step]

After the end of the nucleation step, the pH value of the aqueous solution in the reaction tank for nucleation at a standard liquid temperature of 25° C. is adjusted to 10.5 to 12.0 to form the reaction aqueous solution of the particle growth step. The pH value can also be adjusted by stopping the supply of the alkaline aqueous solution, however, in order to obtain a complex hydroxide having a narrow particle size distribution, it is preferred the pH value be adjusted once the supply of all the aqueous solutions is stopped. More specifically, after the supply of all the aqueous solutions is stopped, it is preferable to adjust the pH value by supplying an inorganic acid having the same group as the metal compound used for preparing the raw material aqueous solution to the reaction aqueous solution.

Next, the supply of the aqueous raw material solution is resumed while stirring this aqueous reaction solution. At this time, since the pH value of the aqueous reaction solution is within the above range, hardly any new nuclei are formed, particle growth progresses, and a crystallization reaction is continued until the secondary particles of the transition metal composite hydroxide reach a specified particle size. Incidentally, since the pH value and the concentration of the ammonium ion concentration of the aqueous reaction solution change as particles grow in the particle growth step, it is necessary to timely supply the alkaline aqueous solution and the ammonia aqueous solution and maintain the pH value and the ammonium ion concentration within the above ranges. Note that the overall reaction time in the particle growth step is usually about 1 hour to 6 hours.

Particularly, in the method for producing the composite hydroxide of the present invention, it is characterized in that from the early period of the particle growth step to the middle period, the non-oxidizing atmosphere is maintained from the nucleation step and the non-oxidizing atmosphere is maintained also in this step. Then, in the latter period of the particle growth step, while maintaining the supply of the raw material aqueous solution, the non-oxidizing atmosphere is switched to the oxidizing atmosphere having an oxygen concentration more than 5% by volume by directly supplying the oxidizing gas to the reaction aqueous solution. After that, while maintaining the supply of the raw material aqueous solution, the oxidizing atmosphere is switched to the non-oxidizing atmosphere again by directly supplying an inert gas to the reaction aqueous solution.

Here, the time for the early period and the middle period of the particle growth step, that is, the time for forming the main portion of the composite hydroxide in the non-oxidizing atmosphere is in a range of 70% to 90% with respect to the entire period of the particle growth step, preferably in a range of 75% to 90%, and more preferably in a range of 80% to 90%. In the present invention, the basic structure of the positive electrode active material that will be obtained is a solid structure, the larger the size of the main portion, the total amount of the electrochemical reaction per volume increases and it is preferable from the view point of sufficiently securing the volume energy density (battery capacity per unit volume). Therefore, it is preferable to grow the secondary particles by sufficiently securing time for the early period and the middle period of the particle growth step. On the other hand, when the duration of the latter period of the particle growth step becomes too short, it becomes impossible to obtain a structure of the composite hydroxide in order to sufficiently obtain the effect of modifying the surface of the secondary particles.

Therefore, in the method for producing the composite hydroxide of the present invention, the latter period of the particle growth step is preferably set to be within a range of 10% to 30%, more preferably within a range of 10% to 25%, even more preferably within a range of 10% to 20%, and the reaction atmosphere in the latter period of this particle growth step is temporary and quickly switched from the non-oxidizing atmosphere to the oxidizing atmosphere so as to form a low-density layer in part near the surface of the secondary particles formed from the plate-shaped primary particles. When the low-density layer is formed in the early period and the middle period, there may be a case where a structure that is different from the solid structure is employed for the secondary particles in the obtained positive electrode active material.

Regarding switching of reaction atmosphere in the latter period of the particle growth step, from the point of switching the non-oxidizing atmosphere to the oxidizing atmosphere, the oxidizing atmosphere is preferably maintained for 0.5% to 20% of time with respect to the entire particle growth step, more preferably within a range of 3% to 15%, even more preferably within a range of 4% to 10% so as to form a low-density layer formed from the fine primary particles. After that, the atmosphere is switched again quickly from the oxidizing atmosphere to the non-oxidizing atmosphere so as to form a portion (outer-shell portion) in the surface of the secondary particles which is formed by aggregates of the plate-shaped primary particles. The non-oxidizing atmosphere is maintained until termination of the particle growth step, that is, it is maintained for time which is in a range of 3% to 20% with respect to the entire particle growth step, preferably within a range of 3% to 18%, more preferably within a range of 4% to 10%.

This switching of the reaction atmosphere is preferably quickly done by directly supplying an inert gas or an oxidizing gas to the reaction aqueous solution in the reaction dank. More specifically, in the present invention, the switching of the reaction atmosphere in the latter period of the particle growth step is made to be possible in a short period of time by directly supplying the atmosphere gas using a diffusing pipe or the like.

In such a method for producing a composite hydroxide, in the nucleation step and the particle growth step, the metal ions in the reaction aqueous solution precipitates as solid nuclei or primary particles. Therefore, the ratio of the liquid component with respect to the amount of metal ion in the reaction aqueous solution increases. As the metal ion concentration of the reaction aqueous solution decreases as the reaction proceeds, in the particle growth step, there is a possibility that the growth of the composite hydroxide may stagnate. Therefore, it is preferable to discharge part of the liquid component of the reaction aqueous solution in the middle of the particle growth step from the termination of the nucleation step in order to suppress the increase of the ratio of the liquid component, that is, the apparent decrease in the metal ion concentration. Specifically, it is preferable to temporarily stop supplying an aqueous solution including the raw material aqueous solution, the alkaline aqueous solution and the ammonium ion donor to the reaction tank and stirring of the reaction aqueous solution so as to precipitate the solid component of the reaction aqueous solution, that is, composite hydroxide, to discharge supernatant liquid of the reaction aqueous solution outside the reaction rank. As the metal ion concentration in the reaction aqueous solution can be maintained due to such an operation, is it possible not only to prevent stagnation of the particle growth and control the particle size distribution of the obtained composite hydroxide to be within a suitable range, but also to improve the density as powder.

[Controlling the Particle Size of the Composite Hydroxide]

The particle size of the secondary particles of the composite hydroxide can be controlled by the time for performing the nucleation step and the particle growth step, and the pH value of the reaction aqueous solution, the supply amount of the raw material aqueous solution, and the like in the respective steps. For example, in the case where the nucleation step is performed at a high pH value, and the time for performing the nucleation step is made longer, or the metal concentration of the raw material aqueous solution is increased, the amount of nuclei generated in the nucleation step increases, and after the particle growth step, a composite hydroxide having a relatively small particle size can be obtained. On the contrary, in the case where the amount of nuclei generated in the nucleation step is suppressed, or the time for performing the particle growth step is made sufficiently long, a composite hydroxide having a large particle size can be obtained.

[Another Form of the Crystallization Reaction]

In the method for producing a complex hydroxide of the present invention, an aqueous solution for component adjustment that is adjusted to a pH value and an ammonium ion concentration suitable for the particle growth step may be prepared separately from the reaction aqueous solution, and to this aqueous solution for component adjustment, the reaction aqueous solution after the nucleation step, preferably the reaction aqueous solution after a part of the liquid component is removed from the reaction aqueous solution after the nucleation step, is added and mixed, and then the particle growth step may be performed using that as the reaction aqueous solution.

In this case, separation of the nucleation step and the particle growth step can be carried out more reliably, so the reaction aqueous solutions in the respective steps can be controlled to an optimum state. Particularly, since the pH value of the aqueous reaction solution can be controlled to be within an optimum range from the start of the particle growth step, the particle size distribution of the obtained composite hydroxide can be narrowed.

(2-3) pH Value

In the method for producing a composite hydroxide of the present invention, the pH value at a standard liquid temperature of 25° C. must be controlled to be within the range of 12.0 to 14.0 when performing the nucleation step, and when performing the particle growth step, the pH value must be controlled to be within the range of 10.5 to 12.0. Note that in both of the steps, it is preferable to control the variation amount of the pH value during the crystallization reaction to be within 0.2 with respect to the set value. In the case where the fluctuation amount of the pH value is large, the amount of nucleation in the nucleation step and the degree of particle growth in the particle growth step are not constant, so it becomes difficult to obtain a complex hydroxide having a narrow particle size distribution.

a) pH Value in the Nucleation Step

In the nucleation step, the pH value of the reaction aqueous solution at a standard liquid temperature of 25° C. must be controlled to be within the range 12.0 to 14.0, and preferably 12.3 to 13.5, and more preferably larger than 12.5 but no larger than 13.3. As a result, it is possible to suppress the growth of nuclei in the reaction aqueous solution and give priority to only nucleation, so the nuclei produced in this step can be made homogeneous and have a narrow particle size distribution. When the pH value is less than 12.0, growth of nuclei proceeds as nucleation progresses, so the particle size of the obtained composite hydroxide becomes nonuniform and the particle size distribution widens. On the other hand, when the pH value is higher than 14.0, the nuclei that are generated become too fine, and there arises a problem in that the reaction aqueous solution gels.

b) pH Value in the Particle Growth Step

In the particle growth step, the pH value of the reaction aqueous solution at a standard liquid temperature of 25° C. must be controlled to be within the range of 10.5 to 12.0, and preferably 11.0 to 12.0, and more preferably 11.5 to 12.0. As a result, generation of new nuclei is suppressed, and it is possible to prioritize particle growth, thus the resulting composite hydroxide can be made homogeneous having a narrow particle size distribution. On the other hand, when the pH value is less than 10.5, the ammonium ion concentration increases and the solubility of the metal ions increases, so not only does the rate of the crystallization reaction slow down but also the amount of metal ions remaining in the reaction aqueous solution increases and the productivity decreases. On the other hand, when the pH value is higher than 12.0, the amount of nucleation during the particle growth step increases, the particle size of the composite hydroxide obtained becomes nonuniform, and the particle size distribution becomes wide.

Further, in either step, the amount of variation of pH value in the crystallization reaction is preferably controlled to be within a range of 0.2 with respect to the set value. When the amount of variation of pH value is large, it is difficult to obtain a composite hydroxide having a narrow particle size distribution as the nucleation amount in the nucleation step and the degree of the particle growth do not become constant.

Incidentally, the case where the pH value of the reaction aqueous solution at a standard liquid temperature of 25° C. is 12.0 is the boundary condition between nucleation and particle growth, so depending on the presence or absence of nuclei present in the reaction aqueous solution, the condition for one of the nucleation step or particle growth step can be set. For example, when the pH value in the nucleation step is set to be higher than 12.0 and a large amount of nuclei are produced, after which the pH value in the particle growth step is set to 12.0, a large amount of nuclei as a reactant is present in the reaction aqueous solution, so particle growth preferentially occurs and a composite hydroxide having a narrow particle size distribution can be obtained. On the other hand, when the pH value in the nucleation step is 12.0, since there are no nuclei growing in the reaction aqueous solution, nucleation preferentially occurs, and by making the pH value in the particle growth step lower than 12.0, it is possible to obtain a good composite hydroxide due to the growth of the generated nuclei.

In any case, the pH value in the particle growth step is controlled to a value lower than the pH value in the nucleation step, and in order to more clearly separate the nucleation and the particle growth, the pH value in the particle growth step is preferably lower than the pH value in the nucleation step by 0.5 or more, and more preferably by 1.0 or more.

(2-4) Reaction Atmosphere

In the method for producing a complex hydroxide of the present invention, together with control of the pH values in the respective steps, control of the reaction atmosphere has an important significance. In the present invention, in the great portion of the nucleation step and the particle growth step, the generated nuclei grow until they become plate-shaped primary particles by maintaining the reaction atmosphere to be a non-oxidizing atmosphere. Therefore, basically, the entire composite hydroxide of the present invention is formed by aggregates of the plate-shaped primary particles. However, in the present invention, in the latter period of the particle growth step, the nuclei grow to the fine primary particles by temporarily switching the reaction atmosphere to the oxidizing atmosphere so as to form the low-density layer near the surface in the structure of the secondary particles by aggregates of such fine primary particles.

a) Non-oxidizing Atmosphere

In the production method of the present invention, basically, the reaction atmosphere in the nucleation step and almost all of the stages of forming the structure of the secondary particles of the composite hydroxide is controlled to be a non-oxidizing atmosphere. Specifically, it is required to use an inert gas such as argon or nitrogen, or a mixed gas of an oxidizing gas such as oxygen and an inert gas so that the oxygen concentration in the reaction atmosphere is 5% by volume or less, preferably 2% by volume or less, more preferably 1% by volume or less. As a result, it is possible to sufficiently reduce the oxygen concentration in the reaction atmosphere and suppress unnecessary oxidation while allowing the nuclei that were generated in the nucleation step to grow until they reach a certain range, so the basic structure of the secondary particles of the composite hydroxide can be made to have an aggregated structure of plate-shaped primary particles having an average particle size of 0.3 μm to 3 μm and a narrow particle size distribution.

b) Oxidizing Atmosphere

On the other hand, in the stage of forming the low-density layer of the composite hydroxide, the reaction atmosphere is controlled to be an oxidizing atmosphere. More specifically, the reaction atmosphere is controlled so that oxygen concentration in the atmosphere in the reaction tank exceeds 5% by volume, and preferably 10% by volume or more, and more preferably atmospheric atmosphere (oxygen concentration: 21% by volume). By controlling the oxygen concentration in the atmosphere in the reaction to such a range, growth of the primary particles is suppressed by sufficiently increasing the oxygen concentration in the reaction atmosphere, and the average particle size of the primary particles becomes 0.01 μm to 0.3 μm, so a low-density layer is formed such that the low-density layer has a sufficient density difference with a portion (the main portion and the outer-shell portion) which is formed by aggregates of the plate-shaped primary particles that form the basic structure of the composite hydroxide.

Incidentally, the upper limit of the oxygen concentration in the reaction atmosphere of this phase is not particularly limited, however, when the oxygen concentration is excessively high, the average particle size of the primary particles becomes less than 0.01 μm, and in some cases the low-density layer may not have sufficient thickness. Therefore, it is preferable that the oxygen concentration is 30% by volume or less. Moreover, in order to clarify the difference between the portion which is formed by aggregates of the plate-shaped primary particles (the main portion and the outer-shell portion) and the low-density layer, the difference in the oxygen concentration before and after switching the atmosphere should be 3% by volume or more, and preferably 10% by volume or more.

c) Timing of Atmosphere Control

The atmosphere control in the particle growth step is required to be performed at an appropriate timing so that a composite hydroxide having a desired particle structure is formed.

In the method for producing the composite hydroxide of the present invention, in the case where the atmospheric gas is directly supplied into the reaction aqueous solution, the reaction atmosphere, or in other words, the dissolved amount of oxygen in the reaction aqueous solution as the reaction field, changes without delay with respect to the change in the oxygen concentration inside the reaction tank. Therefore, the time of switching the atmosphere can be confirmed by measuring the oxygen concentration inside the reaction tank. On the other hand, in the case of supplying the atmospheric gas to a space that comes in contact with the reaction aqueous solution inside the reaction tank, a time lag occurs between the change in dissolved oxygen amount in the reaction aqueous solution and the change in the oxygen concentration inside the reaction tank, so until the oxygen concentration in the reaction solution is stabilized, the correct value of the amount of oxygen dissolved in the reaction aqueous solution cannot be confirmed; however, similarly, the amount of dissolved oxygen can be confirmed by stabilizing the oxygen concentration in the reaction tank and then performing the measurement. In this way, in either case, the time of switching the atmosphere obtained on the basis of the oxygen concentration in the reaction vessel can be taken to be the time of switching of the amount of dissolved oxygen in the reaction aqueous solution as the reaction field, so with the oxygen concentration inside the reaction tank as a reference, it is possible to appropriately perform control of the reaction atmosphere in a timely manner.

The time of switching the atmosphere is about 0.4% to 2% to the entire particle growth step. This time is also common when switching from a non-oxidizing atmosphere to an oxidizing atmosphere or from an oxidizing atmosphere to a non-oxidizing atmosphere. Therefore, even though it is possible to strictly manage the switching time of the atmosphere alone, it is normally sufficient to manage the switching time by including the switching time in the time of the non-oxidizing atmosphere or oxidizing atmosphere after switching the atmosphere.

d) Switching Method

As conventional means for switching the reaction atmosphere during the crystallization step can be generally performed by circulating an atmospheric gas in a reaction tank, and more specifically, in a space in contact with reaction aqueous solution in the reaction tank, or by inserting a conduit having an inner diameter of about 1 mm to 50 mm into the reaction aqueous solution and bubbling the reaction aqueous solution with an atmospheric gas. In these means, it is difficult to switch the atmosphere in a short time of the amount of oxygen dissolved in the reaction aqueous solution like the method for producing the composite hydroxide of the present invention. In addition, during switching the atmosphere from the non-oxidizing atmosphere to the oxidizing atmosphere in the particle growth step, it is necessary to stop the supply of the raw material aqueous solution. Unless the supply of the raw material aqueous solution is stopped, a gentle density gradient is formed inside the composite hydroxide so it is considered that it may become impossible to make the low-density layer to have a sufficient thickness.

On the other hand, in the method for producing the composite hydroxide of the present invention, it is preferred that, during switching the non-oxidizing atmosphere to the oxidizing atmosphere, the atmosphere is switched by directly supplying the atmosphere gas to the reaction aqueous solution while maintaining the supply of the raw material aqueous solution. With this kind of configuration, it is not necessary to stop the supply of the raw material aqueous solution at the time of switching the reaction atmosphere, so the production efficiency can be improved.

Here, the time required for switching the reaction atmosphere by direct supply of the atmospheric gas into the reaction aqueous solution, in other words, the time for switching the atmosphere is not limited as long as a composite hydroxide having the above structure can be obtained, however, from the aspect of simplifying control of the particle structure, the time is within reaction time of the atmosphere to be switched, and preferably is within the range of 0.4% to 2% with respect to the entire time of the particle growth process, and more preferably within the range of 0.4% to 1%.

The supply means of the atmosphere gas to the reaction aqueous solution is required to be means that is able to directly supply the atmosphere gas to the entire reaction aqueous solution. As for such means, for example, it is preferable to use a diffusing pipe. As a diffusing pipe is formed by a conduit having a lot of fine holes at the surface and is able to discharge a lot of fine bubbles in a liquid, the contact area between the reaction aqueous solution and bubbles is large so that the control of time for switching can be easily done according to the supply amount of the atmosphere gas.

As for such a diffusing pipe, it is preferable to use one made of ceramic having an excellent chemical-resistance under a high pH environment. In addition, the smaller the hole diameter, the diffusing pipe can discharge finer bubbles, so it becomes possible to switch the reaction atmosphere in a short time. In the present invention, it is preferable to use a diffusing pipe having a hole diameter of 100 μm or less, more preferably 50 μm or less.

As a method for supplying the atmosphere gas that can be suitably applied to the present invention is arbitrary as long as it generates fine bubbles as described above, and has a large contact area between the reaction aqueous solution and the bubbles. Therefore, any device other than the diffusing pipe can switch the atmosphere similarly with high efficiency by applying device that is able to generate bubbles from the holes of the conduit and crush the bubbles finely and disperse them with a stirring blade or the like.

(2-5) Ammonium Ion Concentration

The concentration of the ammonium ion in the aqueous reaction solution is maintained at a constant value within the range of 3 g/L to 25 g/L, more preferably 5 g/L to 20 g/L. The ammonium ions function as a complexing agent in the aqueous reaction solution, so when the ammonium ion concentration is less than 3 g/L, the solubility of the metal ions cannot be kept constant, and the reaction aqueous solution easily gels, and thus it is difficult to obtain a transition metal composite hydroxide having a uniform shape and particle size. On the other hand, when the ammonium ion concentration exceeds 25 g/L, the solubility of the metal ions becomes too large, so that the amount of metal ions remaining in the reaction aqueous solution increases, which causes a deviation or the like in the composition of the composite hydroxide.

Note that when the ammonium ion concentration fluctuates during the crystallization reaction, the solubility of the metal ions fluctuates and a uniform composite hydroxide may not be formed. Therefore, it is preferable to control the amount of fluctuation of the ammonium ion concentration within a certain range between the nucleation step and the particle growth step, and more specifically, it is preferable to control the amount of fluctuation to within 5 g/L from the set value.

(2-6) Reaction Temperature

The temperature of the reaction aqueous solution, in other words, the reaction temperature of the crystallization reaction must be controlled between the nucleation step and the particle growth step to be preferably within the range of 20° C. or more, and more preferably within the range of 20° C. to 60° C. When the reaction temperature is lower than 20° C., the solubility of the reaction aqueous solution becomes low, which causes nucleation to occur easily, making it difficult to control the average particle size and particle size distribution of the obtained composite hydroxide. It should be noted that the upper limit of the reaction temperature is not particularly limited, however, when the reaction temperature exceeds 60° C., volatilization of ammonia is promoted and the amount of the aqueous solution that includes the ammonium ion donor to be supplied in order to control the ammonium ions in the reaction aqueous solution within a fixed range increases, so the production cost increases.

(2-7) Coating Step

In the method for producing a complex hydroxide of the present invention, by adding a compound that includes an additional element M to the raw material aqueous solution, and particularly to the aqueous raw material solution used in the particle growth step, a composite hydroxide in which the additional element M is uniformly dispersed to the inside of the particles can be obtained. However, in the case of trying to obtain the effect of adding the additional element M with a smaller addition amount, it is preferable that after the particle growth step, a coating step be performed in which the surface of the secondary particles of the transition metal composite hydroxide is coated with a compound that includes the additional element M.

The coating method is not particularly limited as long as the composite hydroxide can be uniformly coated with the compound including the additional element M. For example, after a composite hydroxide is made into a slurry and the pH value thereof is controlled within a specified range, an aqueous solution for coating in which a compound including an additional element M is dissolved is added, and by precipitating out the compound including the additional element M onto the surface of the composite hydroxide, it is possible to obtain a composite hydroxide that is uniformly coated with the compound including the additional element M. In this case, instead of the coating aqueous solution, an aqueous alkoxide solution of the additional element M may be added to the slurry of composite hydroxide. Moreover, without making a slurry of the composite hydroxide, the composite hydroxide may be coated by spraying an aqueous solution or slurry in which the compound including the additional element M is dissolved, and then drying. Furthermore, coating is also possible by a method of spraying and drying a slurry in which composite hydroxide and a compound including an additional element M are suspended, or by a method of mixing composite hydroxide and a compound including an additional element M by a solid phase method, or the like.

Incidentally, in the case of coating the surface of the composite hydroxide with the additional element M, it is necessary to appropriately adjust the composition of the raw material aqueous solution and the coating aqueous solution so that the composition of the composite hydroxide after coating coincides with the composition of the target composite hydroxide. In addition, the coating step may be applied to the heat-treated particles after the heat-treatment of the composite hydroxide in the heat-treatment step at the time of production of the positive electrode active material.

(2-8) Production Apparatus

The crystallizer, or in other words, the reaction tank for producing the composite hydroxide of the present invention is not particularly limited as long as it is possible to perform switching of the reaction atmosphere by means such as a diffusing pipe that directly supplies the atmosphere gas to the reaction tank. In an embodiment of the present invention, it is particularly preferable to use a batch type crystallizer that does not recover the precipitated product until the crystallization reaction is completed. In the case of this kind of a crystallizer, unlike a continuous crystallizer that recovers products by the overflow method, growing particles are not recovered simultaneously with the overflow liquid, so the particle structure that includes a low-density layer and a high-density layer is controlled, and a composite hydroxide having a narrow particle size distribution can be obtained with high accuracy. Moreover, in the method for producing a complex hydroxide of the present invention, it is necessary to appropriately control the reaction atmosphere during the crystallization reaction, so using a closed-type crystallizer is particularly preferred.

3. Positive Electrode Active Material for a Non-Aqueous Electrolyte Secondary Battery

(3-1) Particle Structure of the Positive Electrode Active Material

As illustrated in FIG. 2, the positive electrode active material of the present invention has structural characteristics of including secondary particles formed by an aggregation of a plurality of primary particles, having a tap density of 1.5 g/cm³ or more, and the surface roughness index which is a value in which the measured specific surface area of the secondary particles is divided by the geometric surface area of the secondary particles when the secondary particles is assumed to be true sphere is within a range of 3.6 to 10.

Specifically, when sintering the composite hydroxide, the portion which is formed by aggregates of the plate-shaped primary particles forming the composite hydroxide (the main portion and the outer-shell portion, or, the main portion, the high density layer, and the outer-shell portion) causes sintering shrinkage. On this occasion, as the low-density layer near the surface (between the main portion and the outer-shell portion, or, between the main portion, the high density layer, and the outer-shell portion) is a structure having a lot of gaps made of continuous fine primary particles, the sintering proceeds from the low-temperature area and shrinks to the high-density portion side around the low-temperature area that is formed by the plate-shaped primary particles where the sintering proceeds slowly so as to create a hollow structure. As the sintering shrinkage proceeds over the entire secondary particles, the surface layer (the outer-shell portion) outside the hollow structure shrinks and invaginates so as to crush this hollow structure and form an uneven shape to the surface of the secondary particles due to this invagination.

In the positive electrode active material having this kind of particle structure, the structure of the secondary particles substantially become solid without comprising gaps inside the particles, so it is possible to sufficiently secure the volume energy density (battery capacity per unit volume) by enlarging the total amount of the electrochemical reaction per volume. On the other hand, as an uneven shape is formed on the surface of the secondary particles so as to be able to enlarge the reaction area between the secondary particles and the electrolyte compared with conventional ones, portions where insertion/de-insertion of lithium is possible increase without lowering the tap density. Therefore, in the secondary battery using this positive electrode active material, it is possible to further improve the output characteristics due to the reduction of the positive electrode resistance while maintaining the battery capacity and the cycling characteristics as similar to that of a positive electrode active material having a conventional solid structure with a small particle size and a narrow particle size distribution.

Further, from the point of view of easiness of the insertion/de-insertion of lithium, it is preferable to comprise a crystal structure of the hexagonal layered structure as the crystal structure.

(3-2) Average Particle Size

The average particle size of the secondary particles of the positive electrode active material that can be obtained by the method for producing the positive electrode active material of the present invention is adjusted to be within a range of 1 μm to 15 μm, and preferably 3 μm to 12 μm, and more preferably 3 μm to 10 μm. When the average particle size of the positive electrode active material is within such a range, not only can the battery capacity per unit volume of the secondary battery using this positive electrode active material be increased, but also safety and output characteristics can be improved. However, when the average particle size is less than 1 μm, the filling property of the positive electrode active material is lowered and the battery capacity per unit volume cannot be increased. On the other hand, when the average particle size is larger than 15 μm, the contact interface with the electrolytic solution decreases and the reaction area of the positive electrode active material decreases, so that it becomes difficult to improve the output characteristics.

Note that the average particle size of the positive electrode active material means the volume-based average particle size (MV) as in the case of the above-mentioned composite hydroxide and can be obtained by the volume integrated value that is measured with a laser light diffraction scattering type particle size analyzer.

(3-3) Particle Size Distribution

The value of [(d90−d10)/average particle size], which is an index indicating the spread of the particle size distribution of the secondary particles of the positive electrode active material that is obtained by the method for producing the positive electrode active material of the present invention, is 0.70 or less, and preferably 0.60 or less, and more preferably 0.55 or less, and the positive electrode active material of the present invention forms a powder having a very narrow particle size distribution. This kind of positive electrode active material is such that the ratio of fine particles and coarse particles is small, and a secondary battery using this positive electrode active material has excellent safety, cycle characteristics, and output characteristics.

On the other hand, when the value of [(d90−d10)/average particle size] exceeds 0.70, the ratio of fine particles and coarse particles in the positive electrode active material increases. For example, in a secondary battery using a positive electrode active material having a large ratio of fine particles, the secondary battery is liable to generate heat due to local reaction of the fine particles, so not only the safety deteriorates but also due to the selective deterioration of the particles, the cycle characteristics are inferior. In addition, in a secondary battery using a positive electrode active material having a large ratio of coarse particles, the reaction area of the electrolytic solution and the positive electrode active material cannot be sufficiently maintained and the output characteristics are inferior.

On the other hand, when production on an industrial scale is taken into consideration, it is not practical from the aspect of yield, productivity, or production cost to prepare a powder state in which the value of [(d90−d10)/average particle size] which is an index indicating the spread of the particle size distribution of the positive electrode active material is excessively small as a precursor. Therefore, it is preferable to set the lower limit value of [(d90-d10)/average particle size] to about 0.25.

The meanings of d10 and d90 in the index [(d90−d10)/average particle size] indicating the spread of the particle size distribution in the positive electrode active material are the same as those of the composite hydroxide, therefore, description thereof is omitted.

(3-4) Specific Surface Area

In the positive electrode active material that is obtained by the method for producing the positive electrode active material of the present invention, the specific surface area is preferably 0.7 m²/g to 3.0 m²/g, and more preferably 1.0 m²/g to 2.0 m²/g. The positive electrode active material having a specific surface area within such a range has a large contact area with the electrolytic solution, and the output characteristics of a secondary battery using this positive electrode active material can be greatly improved. However, when the specific surface area of the positive electrode active material is less than 0.7 m²/g, it is impossible to maintain a reaction area with the electrolytic solution when forming a secondary battery, and it is difficult to sufficiently improve the output characteristics. On the other hand, when the specific surface area of the positive electrode active material is larger than 3.0 m²/g, the reactivity with the electrolytic solution becomes too high, so that thermal stability may be lowered in some cases.

Here, the specific surface area of the positive electrode active material can be measured, for example, using the BET method by nitrogen gas adsorption.

(3-5) Tap Density

Making the capacity of a secondary battery higher has become an important issue in order to make the operating time of portable electronic devices longer and the travel distance of an electric car longer. On the other hand, the thickness of the electrode of a secondary battery is required to the about a few μm due to packing of the entire battery and electron conductivity. Therefore, it is required not only to use a positive electrode active material having a high capacity, but also to improve the filling property of the positive electrode active material in order to make the capacity higher as a whole secondary battery.

From this kind of point of view, in the positive electrode active material of the present invention, the tap density, which is an index of the filling property (the sphericity of the secondary particles of the positive electrode active material), is preferably 1.5 g/cm³ or more, more preferably 1.6 g/cm³ or more, and more preferably 1.8 g/cm³ or more, and even more preferably 2.0 g/cm³ or more. When the tap density is less than 1.5 g/cm³, the filling property is low and the battery capacity of the whole secondary battery cannot be sufficiently improved in some cases. On the other hand, the upper limit of the tap density is not particularly limited, however, the upper limit under ordinary manufacturing conditions is about 3.0 g/cm³.

Note that the tap density represents the bulk density after tapping the sample powder collected in a container 100 times, based on JIS Z 2512:2012, and can be measured using a shaking specific gravity measuring device.

(3-6) Surface Roughness Index

The positive electrode active material of the present invention is characterized in forming a larger uneven shape on the surface of the secondary particles of the positive electrode active material compared to that of conventional structure. In the present invention, in order to quantitatively evaluate and assess the roughness of the particle surface that was caused due to the degree of the unevenness of the surface of this positive electrode active material, that is, caused by comprising an uneven shape, the surface roughness index of the surface of the secondary particles is used. The surface roughness of this surface is defined as shown in formula (1). That is, the surface roughness index is a value which is defined as specific surface area of the positive electrode active material that is normalized by the particle size of the positive electrode active material and the specific surface area of the particle that is measured by the BET method is divided by the geometric surface area when assuming the particles as sphericity.

In the formula (1), SSA_{BET} means the specific surface area of the particles measured by the BET method, and its unit is cm²/g. Further, as indicated in the formula (2), SSA_{SPHE} means the geometric surface area when assuming the particles as sphericity, and its unit is cm²/g. Here, r is the particle radius of the secondary particles of the positive electrode active material, and DR is the true density of the positive electrode active material. This true density can be obtained by the true density measurement device using a gas replacement method or a vapor adsorption method.

$$\begin{matrix}[ Equation 1 ] & \\ surface roughness index = \frac{{SSA}_{BET}}{{SSA}_{SPHE}} & ( 1 ) \\ [ Equation 2 ] & \\ {SSA}_{SPHE} = \frac{4 π {r}^{2}}{\frac{4}{3} π {r}^{3} \times {D}_{R}} = \frac{3}{r \times {D}_{R}} & ( 2 )\end{matrix}$$

In the positive electrode active material of the present invention, said surface roughness index is within a range of 3.6 to 10, preferably within a range of 3.6 to 8, more preferably within a range of 3.6 to 6. As this surface roughness index is within the above ranges, the positive electrode active material comprises more unevenness of the particle surface so as to have a larger specific surface area compared to the particles having a regular structure, and a large reduction effect can be obtained in the positive electrode resistance as the reaction area with the electrolyte increases. Further, as it has high tap density, the packing density in the battery container becomes high as well, and by using it as the positive electrode of a battery, it is possible to obtain a battery having high volume energy density and excellent output characteristics. On the other hand, when the surface roughness index is less than 3.6, the contact area between the surface of the secondary particles and the electrolyte or the conductive aid does not become sufficiently large and the effect of reducing the positive electrode resistance cannot be sufficiently obtained.

In the present invention, the upper limit value of the surface roughness index of the surface is limited by the structure of the secondary particles. That is, when the surface roughness index becomes too large, the unevenness of the particle surface becomes excessively large and the gaps become large when the particles contact with each other, the tap density becomes less than 1.5 g/cm³, the filling property of the positive electrode active material lowers, and there may be a probability that it becomes impossible to sufficiently improve the battery capacity of the entire secondary battery. Therefore, it is required to set the upper limit value of the surface roughness index by considering the structure of the secondary particles, the average particle size, the particle size distribution, and the specific surface area. In case of the positive electrode active material of the present invention, the surface roughness index becomes said ranges when the tap density is sufficiently secured, that is, set to be 1.5 g/cm³ or more while sufficiently securing the contact area between the surface of the secondary particles, the electrolyte and the conductive aid.

(3-7) Composition

The positive electrode active material that is obtained by the method for producing the positive electrode active material of the present invention has characteristics in its particle structure of the secondary particles, so as long as it has the particle structure described above, its composition is not specifically limited. However, it is preferable that is comprises a hexagonal lithium nickel manganese composite oxide that is expressed by a general formula (B): Li₁₊ᵤNiₓMn_{y}Co_{z}MₜO₂, where −0.05≤u≤0.50, x+y+z+t≤=1, 0.3≤x≤0.95, 0.05≤y≤0.55, 0≤z≤0.4, 0≤t≤0.1, and M is one or more additional element selected from Mg, Ca, Al, Ti, V, Cr, Zr, Nb, Mo, Hf, Ta, and W.

In this positive electrode active material, the value of “u” that indicates the excess amount of lithium (Li) is preferably no less than −0.05 and no greater than 0.50, and more preferably no less than 0 and no greater than 0.50, and even more preferably no less than 0 and no more and 0.35. By setting the value of “u” within the above-described range, it is possible to improve the output characteristics and the battery capacity of a secondary battery using this positive electrode active material as the positive electrode material. However, when the value of “u” is less than −0.05, the positive electrode resistance of the secondary battery increases, so the output characteristics cannot be improved. On the other hand, when “u” is larger than 0.50, not only the initial discharge capacity decreases, but also the positive electrode resistance increases.

Nickel (Ni) is an element contributing to high potential and high capacity of the secondary battery, and the value of “x” indicating the content thereof is preferably no less than 0.3 and no more than 0.95, and more preferably no less than 0.3 and no more than 0.9. When the value of “x” is less than 0.3, the battery capacity of a secondary battery using this positive electrode active material cannot be improved. On the other hand, when the value of “x” exceeds 0.95, the content of other metallic elements decreases, and the effects of those elements cannot be obtained.

Manganese (Mn) is an element contributing to the improvement of thermal stability, and the value of “y” indicating the content thereof is preferably no less than 0.05 and no more than 0.55, and more preferably no less than 0.10 and no more than 0.40. When the value of “y” is less than 0.05, the thermal stability of a secondary battery using this positive electrode active material cannot be improved. On the other hand, when the value of “y” exceeds 0.55, Mn is eluted from the positive electrode active material during high temperature operation, thereby deteriorating the charge and discharge cycle characteristics.

Cobalt (Co) is an element contributing to improvement of the charge-discharge cycle characteristics, and the value of “z” indicating the content thereof is preferably no less than 0 and no more than 0.4, and more preferably no less than 0.10 and no more than 0.35. When the value of “z” exceeds 0.4, the initial discharge capacity of a secondary battery using this positive electrode active material is greatly reduced.

In the positive electrode active material that is obtained by the method for producing the positive electrode active material of the present invention, in order to further improve the durability and output characteristics of the secondary battery, an additional element M may be contained in addition to the above-described transition metal elements. As such an additional element M, it is possible to use one or more kind selected from magnesium (Mg), calcium (Ca), aluminum (Al), titanium (Ti), vanadium (V), chromium (Cr), zirconium (Zr), niobium (Nb), molybdenum (Mo), hafnium (Hf), tantalum (Ta), and tungsten (W).

The value of “t” indicating the content of the additional element M is preferably no less than 0 and no more than 0.1, and more preferably no less than 0.001 and no more than 0.05. When the value of “t” is larger than 0.1, the metallic element contributing to the Redox reaction decreases, so the battery capacity decreases.

This kind of additional element M may be uniformly dispersed inside the particles of the positive electrode active material or may be coated on the surface of the particle of the positive electrode active material. Furthermore, the additional element M may be uniformly dispersed inside of the particles and coated on the surface thereof. In any case, it is necessary to control the content of the additional element M to be within the above-describe range.

Incidentally, in the case of the above-described positive electrode active material, in order to further improve the battery capacity of a secondary battery using this positive electrode active material the composition thereof is preferable adjusted so at to be represented by the general formula (B1): Li₁₊ᵤNiₓMn_{y}Co_{z}MₜO₂, where −0.05≤u≤0.20, x+y+z+t=1, 0.7<x≤0.95, 0.05≤y≤0.1, 0≤z≤0.2, 0≤t≤0.1, and M is one or more kind of additional element selected from among Mg, Ca, Al, Ti, V, Cr, Zr, Nb, Mo, and W. Particularly, when compatibility with thermal stability is to be attained, it is more preferable to set the value of “x” in the general formula (B1) to 0.7<x≤0.9, and even more preferably to 0.7<x≤0.85.

On the other hand, in order to further improve the thermal stability, the composition of the positive electrode active material is preferably adjusted so as to be represented by the general formula (B2): Li₁₊ᵤNiₓMn_{y}Co_{z}MₜO₂, where −0.05≤u≤0.50, x+y+z+t=1, 0.3≤x≤0.7, 0.1≤y≤0.55, 0≤z≤0.4, 0≤t≤0.1, and M is one or more kind of additional element selected from among Al, Ti, V, Cr, Zr, Nb, Mo, Hf, Ta and W.

4. Method for Producing Positive Electrode Active Material for a Non-Aqueous Electrolyte Secondary Battery

The method for producing the positive electrode active material of the present invention is not particularly limited as long as the method can use the above-described composite hydroxide as a precursor to form a positive electrode active material having a specified structure, average particle size, and particle size distribution. However, in the case of performing production on an industrial scale, preferably the positive electrode active material is formed by a production method that includes a mixing step of mixing the above-mentioned composite hydroxide with a lithium compound to obtain a lithium mixture, and a firing step of firing the obtained lithium mixture in an oxidizing atmosphere at a temperature of 650° C. to 1000° C. Incidentally, if necessary, steps such as a heat-treatment step, a pre-firing step and the like may be added to the above-mentioned steps. With this kind of production method, the above-described positive electrode active material, and particularly the positive electrode active material represented by the general formula (B) can be easily obtained.

(4-1) Heat-Treatment Step

In the method of producing the positive electrode active material of the present invention, and heat-treated particles obtained by heat-treating a composite hydroxide may be mixed with a lithium compound. Here, as the heat-treated particles, not only the composite hydroxide from which excess moisture has been removed in the heat-treatment step, but also a transition metal-containing composite oxide obtained by converting the composite hydroxide into an oxide in this heat-treatment step, or a mixture thereof are also included.

The heat-treatment step is a step of removing excess moisture included in the composite hydroxide by heating the composite hydroxide to a temperature in the range of 105° C. to 750° C. As a result, moisture remaining until the firing step can be reduced to a certain amount, and variation in the composition of the obtained positive electrode active material can be suppressed. When the heating temperature is lower than 105° C., excessive moisture in the composite hydroxide cannot be removed, and the variation cannot be sufficiently suppressed in some cases. On the other hand, when the heating temperature is higher than 750° C., further effects cannot be expected, however the production cost increases.

Moreover, in the heat-treatment step, it is sufficient that moisture can be removed to such an extent that the number of atoms of each metal component in the positive electrode active material and the ratio of the number of atoms of Li do not vary, so it is not always necessary to convert all of the composite hydroxide to composite oxide. However, in order to reduce variations in the number of atoms of the respective metal components and the ratio of the number of atoms of Li, preferably heating is performed at 400° C. or more to convert all of the composite hydroxide to complex oxide. Note that by using chemical analysis to previously determine the metal component ratio included in the composite hydroxide according to the heat-treatment condition and determine the mixing ratio with the lithium compound, it is possible to further suppress the above-mentioned variation.

The atmosphere under which the heat-treatment is performed is not particularly limited, and may be a non-reducing atmosphere, however it is preferable to perform the heat-treatment in a flow of air that can be easily performed.

The heat-treatment time is not particularly limited, however, from the aspect of sufficiently removing excess moisture in the composite hydroxide, the heat-treatment time is preferably at least 1 hour, and more preferably 5 hours to 15 hours.

(4-2) Mixing Step The mixing step is a step of mixing a lithium compound into a composite hydroxide or heat-treated particles to obtain a lithium mixture.

In the mixing step, it is necessary to mix the composite hydroxide or heat-treated particle with the lithium compound so that the ratio (Li/Me) of the number (Me) of metal atoms other than lithium in the lithium mixture, more specifically, the sum of the number of atoms of nickel, cobalt, manganese, and additional element M, and the number (Li) of atoms of lithium becomes 0.95 to 1.5, and preferably 1.0 to 1.5, and more preferably 1.0 to 1.35, and even more preferably 1.0 to 1.2. In other words, the value of Li/Me does not change before and after the firing step, so it is necessary to mix the composite hydroxide or heat-treated particle with the lithium compound so that the value of Li/Me in the mixing step becomes the Li/Me value of the target positive electrode active material.

The lithium compound used in the mixing step is not particularly limited, however, from the aspect of availability, it is preferable to use lithium hydroxide, lithium nitrate, lithium carbonate, or a mixture thereof. Particularly, taking into consideration the ease of handling and stability of quality, it is preferable to use lithium hydroxide or lithium carbonate.

It is preferable that the composite hydroxide or heat-treated particles and the lithium compound are mixed sufficiently so as not to produce fine powder. When mixing is insufficient, the value of Li/Me varies among the individual particles, and sufficient battery characteristics may not be obtained in some cases. Incidentally, for mixing, a general mixer can be used. For example, a shaker mixer, a Lodige mixer, a Julia mixer, a V blender, or the like may be used.

(4-3) Pre-firing Step

In the case where lithium hydroxide or lithium carbonate is used as the lithium compound, after the mixing step and before the firing step, a pre-firing step may be performed in which the lithium mixture is pre-fired at a temperature lower than the firing temperature at 350° C. to 800° C., and preferably at 450° C. to 780° C. As a result, lithium can be sufficiently diffused into the composite hydroxide or heat-treated particles, and a more uniform positive electrode active material can be obtained.

Incidentally, the holding time at the above temperature is preferably 1 hour to 10 hours, and more preferably 3 hours to 6 hours. In addition, the atmosphere in the pre-firing step is preferably an oxidizing atmosphere, similar to the firing step described later, more preferably is an atmosphere having an oxygen concentration of 18% by volume to 100% by volume.

(4-4) Firing Step

In the firing step, the lithium mixture obtained in the mixing step is fired under specified conditions to diffuse lithium into the composite hydroxide or heat-treated particles to obtain a positive electrode active material.

In this firing step, while the outer-shell portion or the outmost portion of the composite hydroxide and the heat-treated particles causes sintering shrinkage, sintering of the low-density layer formed from the fine primary particles existing near the surface proceeds from the low temperature area and is further progressed compared to the portion (the main portion and the outer-shell portion) formed from the plate-shaped primary particles and exists around the low temperature area. Therefore, the fine primary particles included in the low-density layer cause sintering shrinkage toward the main portion and the outer-shell portion where sintering proceeds slowly to form a hollow structure, however, as the outer-shell portion or the outmost portion invaginates so as to crush this hollow structure as the outer-shell portion or the outmost portion shrinks, an uneven shape is formed on the surface of the secondary particles. As a result, in the case of applying the positive electrode active material obtained as described above as the positive electrode material of a secondary battery, it is possible to improve the output characteristics without impairing the battery capacity as the internal resistance largely decreases.

The particle structure of this kind of positive electrode active material is basically determined according to the particle structure of the composite hydroxide which is a precursor, however, since the particle structure may be influenced by the composition, firing conditions and the like, after performing a preliminary test, it is preferable to appropriately adjust the respective condition so that a desired structure is obtained.

The furnace used in the firing step is not particularly limited, and any furnace capable of firing the lithium mixture in air or an oxygen flow may be used. However, from the viewpoint of keeping the atmosphere in the furnace uniform, an electric furnace free from gas generation is preferable, and either a batch type or a continuous type electric furnace may be suitably used. In regard to this point, the same also applies to furnaces used for the heat-treatment step and the pre-firing step.

a) Firing Temperature

It is necessary for the firing temperature of the lithium mixture to be 650° C. to 1000° C. When the firing temperature is lower than 650° C., lithium does not sufficiently diffuse into the composite hydroxide or heat-treated particles, excess lithium or unreacted composite hydroxide or heat-treated particles remain, or the crystallinity of the obtained positive electrode active material may become insufficient in some cases. On the other hand, when the firing temperature is higher than 1000° C., extreme sintering occurs among the particles of the positive electrode active material, causing abnormal particle growth, and the ratio of amorphous coarse particles increases.

In the case where it is desired to obtain a positive electrode active material represented by the above-described general formula (B1), it is preferable for the firing temperature to be 650° C. to 900° C. On the other hand, in the case of trying to obtain the positive electrode active material represented by the general formula (B2), it is preferable for the firing temperature to be 800° C. to 980° C.

In addition, the rate of increased temperature in the firing step is preferably 2° C./min to 10° C./min, and more preferably 5° C./min to 10° C./min. Furthermore, during the firing step, it is preferable to maintain the temperature at around the melting point of the lithium compound for 1 hour to 5 hours, and more preferably 2 hours to 5 hours. As a result, the composite hydroxide or the heat-treated particles and the lithium compound can be more uniformly reacted.

b) Firing Time

Of the firing time, the holding time at the above-described firing temperature is preferably at least 2 hours, and more preferably 4 hours to 24 hours. When the holding time at the firing temperature is less than 2 hours, lithium does not sufficiently diffuse into the composite hydroxide or heat-treated particles, excess lithium or unreacted complex hydroxide or heat-treated particles remain, or crystallinity of the obtained positive electrode active material may be insufficient.

Note that after completion of the holding time, the cooling rate from the firing temperature to at least 200° C. is preferably 2° C./min to 10° C./min, and more preferably 33° C./min to 77° C./min. By controlling the cooling rate within this kind of a range, it is possible to prevent equipment such as a sagger from being damaged by rapid cooling while maintaining productivity.

c) Firing Atmosphere

The atmosphere at the time of firing is preferably an oxidizing atmosphere, and more preferably is an atmosphere having an oxygen concentration of 18% by volume to 100% by volume, and particularly it is preferable to use a mixed atmosphere of oxygen having the above-described oxygen concentration and an inert gas. In other words, it is preferable that firing be carried out in an air atmosphere or in an oxygen flow. When the oxygen concentration is less than 18% by volume, the crystallinity of the positive electrode active material may be insufficient.

(4-5) Disintegration Step

In some cases, the positive electrode active material obtained by the firing step is aggregated or somewhat sintered. In such a case, it is preferable to physically disintegrate the aggregate or sintered body of the positive electrode active material. As a result, it is possible to adjust the average particle size and particle size distribution of the obtained positive electrode active material to be within a suitable range. It should be noted that disintegration is a process in which mechanical energy is added to an aggregate of a plurality of secondary particles generated by sintering necking or the like between secondary particles at the time of firing, and to loosen the aggregate by separating the secondary particles.

As the disintegrating method, a known means can be used, for example, a pin mill, a hammer mill or the like may be used. Incidentally, at this time, it is preferable to adjust the disintegrating force to be within an appropriate range so as not to destroy the secondary particles.

5. Non-Aqueous Electrolyte Secondary Battery

The non-aqueous electrolyte secondary battery of the present invention includes the same components as a general non-aqueous electrolyte secondary battery such as a positive electrode, a negative electrode, a separator, and a non-aqueous electrolytic solution. It should be noted that the embodiment described below is merely an example, and the non-aqueous electrolyte secondary battery of the present invention is such that various modified and improved forms may be applied based on the embodiments described in this specification.

(5-1) Components

a) Positive Electrode

Using the positive electrode active material as described above, for example, a positive electrode of a non-aqueous electrolyte secondary battery is prepared as described below.

First, a conductive material and a binding agent are mixed into the positive electrode active material of the present invention, activated carbon or a solvent for viscosity control or the like is added if necessary, and these are kneaded to prepare a positive electrode composite paste. At that time, the mixing ratio of each in the positive electrode mixture paste also becomes an important factor for determining the performance of the non-aqueous electrolyte secondary battery. For example, in the case where the solid content of the positive electrode material mixture excluding the solvent is taken to be 100 parts by mass, as in the case of the positive electrode of a general non-aqueous electrolyte secondary battery, the content of the positive electrode active material may be taken to be 60 parts by mass to 95 parts by mass, the content of the conductive material may be taken to be 1 parts by mass to 20 parts by mass, and the content of the binding agent may be taken to be 1 part by mass to 20 parts by mass.

The obtained positive electrode composite paste is coated on the surface of a current collector made of aluminum foil, for example, and dried to scatter the solvent. When necessary, pressure may be applied by a roll press or the like in order to increase the electrode density. In this way, a sheet-like positive electrode can be produced. The sheet-like positive electrode can be cut into an appropriate size depending on the intended battery and used for manufacturing the battery. Note that the method for manufacturing the positive electrode is not limited to the example described above, and other methods may be used.

As the conductive material, for example, graphite (natural graphite, artificial graphite, expanded graphite, and the like), carbon black material such as acetylene black, ketjen black and the like can be used.

The binding agent plays a role of binding the active material particles, and, for example, polyvinylidene fluoride (PVDF), polytetrafluoroethylene (PTFE), fluororubber, ethylene propylene diene rubber, styrene butadiene, cellulose resin or polyacryl acid can be used.

In addition, when necessary, a solvent capable of dispersing the positive electrode active material, the conductive material and the activated carbon, and dissolving the binding agent can be added to the positive electrode material mixture. More specifically, organic solvents such as N-methyl-2-pyrrolidone and the like can be used as the solvent. In addition, activated carbon can be added to the positive electrode mixture to increase the electric double layer capacity.

b) Negative Electrode

For the negative electrode, metallic lithium, a lithium alloy or the like can be used. Moreover, a paste-like negative electrode mixture obtained by mixing a binding agent with a negative electrode active material capable of insertion/de-insertion of lithium ions and adding an appropriate solvent is applied to the surface of a metal foil current collector such as copper and dried, and as necessary compressed so as to increase the electrode density, can be used.

As the negative electrode active material, for example, powdery lithium-containing substances such as metallic lithium, lithium alloys, and the like, organic graphite fired bodies capable of insertion/de-insertion of lithium ions such as natural graphite, artificial graphite, phenolic resin, and the like, and carbon materials such as coke can be used. In this case, as the negative electrode binding agent, as in the case of the positive electrode, a resin that includes fluorine such as PVDF or the like can be used, and as a solvent for dispersing the active material and the binding agent, an organic solvent such as N-methyl-2-pyrrolidone or the like can be used.

c) Separator

The separator is sandwiched and arranged between the positive electrode and the negative electrode and has a function of separating the positive electrode and the negative electrode and holding the electrolyte. As this kind of a separator, for example, a thin film made of polyethylene, polypropylene or the like and having many fine pores can be used, however is not particularly limited as long as the separator has the function described above.

d) Non-aqueous Electrolyte

The non-aqueous electrolyte is one in which lithium salt as a supporting salt is dissolved to an organic solvent.

As the organic solvent, one kind alone, or a mixture of two or more kinds selected from

cyclic carbonates such as ethylene carbonate, propylene carbonate, butylene carbonate, trifluoropropylene carbonate, and the like;

chain carbonates such as diethyl carbonate, dimethyl carbonate, ethyl methyl carbonate, dipropyl carbonate, and the like;

ether compounds such as tetrahydrofuran, 2-methyltetrahydrofuran, dimethoxyethane, and the like;

sulfur compounds such as ethyl methyl sulfone, butane sultone, and the like; and

phosphorus compounds such as triethyl phosphate, trioctyl phosphate, and the like can be used.

As the supporting salt, LiPF₆, LiBF₄, LiClO₄, LiAsF₆, LiN(CF₃SO₂)₂, complex salts of these and the like can be used.

Incidentally, the non-aqueous electrolytic solution may include a radical scavenger, a surfactant, a flame retardant, or the like.

(5-2) Construction

The non-aqueous electrolyte secondary battery of the present invention comprising the positive electrode, the negative electrode, the separator, and the non-aqueous electrolyte described above can have various shapes such as a cylindrical shape, a laminated shape, and the like.

Regardless of which shape is adopted, a positive electrode and a negative electrode are laminated via a separator to form an electrode body, the obtained electrode body is impregnated with a non-aqueous electrolytic solution, a current collecting lead or the like is used to connect between the positive electrode current collector and a positive electrode terminal leading to the outside, and between the negative electrode current collector and a negative electrode terminal leading to the outside, and the contents are then sealed in a battery case to complete the non-aqueous electrolyte secondary battery.

(5-3) Characteristics

As described above, the non-aqueous electrolyte secondary battery of the present invention uses the positive electrode active material of the present invention as a positive electrode material, so while maintaining the battery capacity and the cycling characteristics as similar to that of a non-aqueous electrolyte secondary battery using a conventional positive electrode active material of the solid structure, the output characteristics is drastically improved. Moreover, in comparison with a secondary battery using a positive electrode active material comprising a conventional lithium nickel composite oxide, thermal stability and safety are in a level having no problems.

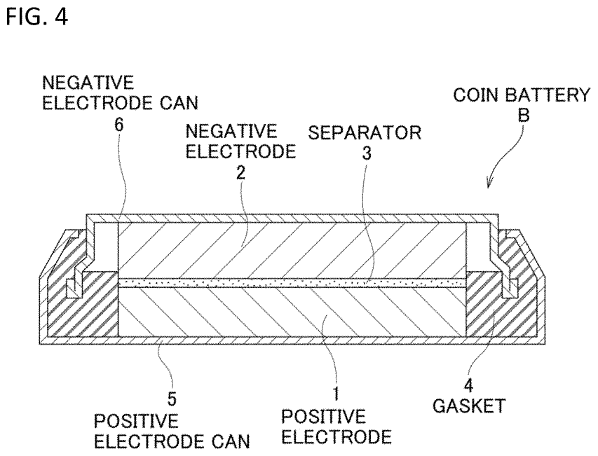

For example, when a 2032-type coin battery as illustrated in FIG. 4 is constructed by using the positive electrode active material of the present invention, an initial discharge capacity of 150 mAh/g or more, and preferably 158 mAh/g or more, a positive electrode resistance of 1.5Ω or less, preferably 1.4Ω or less, more preferably 1.3Ω or less, and a 500 cycle capacity retention rate of 75% or more, and preferably 80% or more can be achieved at the same time.

(5-4) Uses

As described above, the non-aqueous electrolyte secondary battery of the present invention has excellent battery capacity, output characteristics, and cycle characteristics, and can be suitably used as a power source for small portable electronic devices (laptop personal computers, mobile phones, and the like) that are required to have these characteristics at a high level. In addition, of these characteristics, the non-aqueous electrolyte secondary battery of the present invention has greatly improved output characteristics and is excellent in safety, and not only can this non-aqueous electrolyte secondary battery be made to be more compact and have higher output, expensive protection circuitry can be simplified, so this non-aqueous electrolyte secondary battery can be suitably used as a power supply for transportation equipment such as electric cars and hybrid cars in which the mounting space is limited.

### EXAMPLES

In the following, the present invention will be described in detail using Examples and Comparative Examples. Moreover, these examples correspond to an example of embodiments of the present invention, and the present invention is not limited to the contents of these examples. In the following Examples and Comparative Examples, unless otherwise specified, samples of special grade reagents manufactured by Wako Pure Chemical Industries, Ltd. were used for preparing the composite hydroxide and the positive electrode active material, respectively. In addition, during the nucleation step and the particle growth step, the pH value of the aqueous reaction solution was measured with a pH controller (NPH-690D, manufactured by Nissin Rika Co., Ltd.), and by adjusting the amount of sodium hydroxide aqueous solution supplied based on of the measured value, the pH value of the reaction aqueous solution in each step was controlled within the range of a variation amount of ±0.2 with respect to the setting value for the step.

### Example 1

a) Production of a Transition Metal Composite Hydroxide

[Nucleation Step]

First, 1.4 L of water was placed in a 6 L reaction tank, and the temperature in the tank was set at 40° C. while stirring. When doing this, nitrogen gas was circulated in the reaction tank for 30 minutes, and the reaction atmosphere was set to the non-oxidizing atmosphere having the oxygen concentration of 2% by volume or less. Continuing, a pre-reaction aqueous solution was formed by supplying an appropriate amount of 25% by mass sodium hydroxide aqueous solution and 25% by mass ammonia water into the reaction tank, adjusting the pH value at a standard liquid temperature of 25° C. to 12.8, and adjusting the ammonium ion concentration to be 10 g/L. Simultaneously, nickel sulfate, cobalt sulfate, manganese sulfate and zirconium sulfate were dissolved in water so that the molar ratio of the respective metal elements was Ni:Mn:Co:Zr=33.1:33.1:33.1:0.2, and 2 mol/L of a raw material aqueous solution was prepared.

Next, this raw material aqueous solution was supplied to the pre-reaction aqueous solution at a flow rate of 10 ml/min to form a reaction aqueous solution, and nucleation was carried out for 3 minutes by a crystallization reaction. During this process, a 25% by mass sodium hydroxide aqueous solution and 25% by mass ammonia water were supplied in a timely manner so that the pH value and the ammonium ion concentration is maintained within said ranges.

[Particle Growth Step]

After completion of the nucleation step, supply of all the aqueous solutions into the reaction tank was temporarily stopped, sulfuric acid was then added, and the pH value of the reaction aqueous solution was adjusted to 11.6 at a standard liquid temperature of 25° C. After confirming that the pH value reached a specified value, a raw material aqueous solution and a sodium tungstate aqueous solution were supplied to cause the nuclei generated in the nucleation step to grow.

After a lapse of 200 minutes (83.4% of the entire time of the particle growth step) from the start of the particle growth step, while continuing to supply the raw material aqueous solution, a ceramic diffusing tube (Kinoshita Rika Kogyo) having a pore size of 20 μm to 30 μm was used to circulate air in the reaction aqueous solution to adjust the reaction atmosphere to an oxidizing atmosphere having an oxygen concentration of 21% by volume (switching operation 1).

After 20 minutes from the start of the switching operation 1 (8.3% with respect to the entire time of the particle growth step), while continuing the supply of the raw material aqueous solution, a nitrogen gas was circulated in the reaction tank and the reaction atmosphere was adjusted to a non-oxidizing atmosphere having an oxygen concentration of 2% by volume or less (switching operation 2).

Then, after 20 minutes from the switching operation 2 (8.3% with respect to the entire time of the particle growth step), supply of all aqueous solutions was stopped, and the particle growth step was terminated. During this operation, a 25% by mass sodium hydroxide aqueous solution and 25% by mass ammonia water were supplied in a timely manner to maintain the pH value and the ammonium ion concentration of the reaction aqueous solution within the above ranges.

At this time, the concentration of the product in the reaction aqueous solution was 86 g/L. After that, the obtained product was washed with water, filtered, and dried to obtain a powdery composite hydroxide.

b) Evaluation of the Composite Hydroxide

[Composition]

With this composite hydroxide as a sample, the elemental fraction was measured using an ICP emission spectroscopic analyzer (ICPE-9000, manufactured by Shimadzu Corporation), and this composite hydroxide was confirmed to have a composition represented by the general formula: Ni_{0.331}Mn_{0.331}Co_{0.331}Zr_{0.002}W_{0.005}(OH)₂.

[Particle Structure]

By observing the composite hydroxide with a field emission type scanning electron microscope (FE-SEM: JSM-6360LA, manufactured by JEOL Ltd.), it was confirmed that this composite hydroxide was formed from secondary particles that were mostly spherical and had substantially a uniform particle size. In addition, a part of the composite hydroxide was embedded in resin, and a cross section of the particles was made observable by performing a cross sectional polishing process, and observed using an SEM (JSM-6360LA, manufactured by JEOL Ltd.). As a result, the secondary particles of this composite hydroxide were confirmed to be formed by aggregates of the plate-shaped primary particles overall, and a low-density layer formed by aggregates of the fine primary particles exist near the surface of the secondary particles, and a structure similar to the schematic structure illustrated in FIG. 1 was obtained. This low-density layer existed within the range of 18% from the surface of the secondary particles with respect to the particle size of the secondary particles. Further, the average particle size of the fine primary particles was 0.2 μm, and the average particle size of the plate-shaped primary particles was 0.5 μm. Furthermore, the low-density layer ratio to particle size was 5%. The main portion ratio to particle size, the low-density layer ratio to particle size, and the outer-shell portion ratio to particle size were also measured and calculated to be 82%, 5%, and 4%, respectively.

[Average Particle Size and Particle Size Distribution]

Measurement of the average particle size of the composite hydroxide and measurement of d10 and d90 were performed using a laser light diffraction scattering type particle size analyzer (Microtrac HRA, manufactured by Nikkiso Co., Ltd.), and the value of [(d90−d10)/average particle size], which is an index indicating the spread of the particle size distribution was calculated. As a result, the average particle size of the composite hydroxide was 5.2 μm, and the value of [(d90−d10)/average particle size] was 0.42.

c) Production of Positive Electrode Active Material

As a heat-treatment step, a heat-treatment was performed on this composite hydroxide for 12 hours at 120° C. in a flow of air in an air atmosphere (oxygen concentration: 21% by volume) to obtain heat-treated particles. Thereafter, as a mixing step, the composite hydroxide after heat-treatment and lithium carbonate were mixed so that the value of Li/Me became 1.14, and sufficiently mixed using a shaker mixer (TURBULA Type T2C, manufactured by Willy A Bachofen (WAB)) to obtain a lithium mixture.

Next, as a firing step, firing was performed on this lithium mixture, and in this firing step, in a flow of air in an air atmosphere (oxygen concentration: 21% by volume), the temperature was raised from room temperature to 950° C. at a rate of temperature rise of 2.5° C./min and maintained and fired at this temperature for 4 hours, and then cooled to room temperature at a cooling rate of about 4° C./min. Aggregation or light sintering occurred in the positive electrode active material obtained in this way, so a disintegration step was performed, and this positive electrode active material was disintegrated to adjust the average particle size and particle size distribution.

d) Evaluation of the Positive Electrode Active Material

[Composition]

Using this positive electrode active material as a sample, the elemental fraction was measured using an ICP emission spectroscopic analyzer, and as a result, it was confirmed that this positive electrode active material was represented by the general formula: Li_{1.14}Ni_{0.331}Mn_{0.331}Co_{0.331}Zr_{0.002}W_{0.005}O₂.

[Particle Structure]

The surface of this positive electrode active material was observed using an SEM (refer to FIG. 2). As a result, this positive electrode active material was formed by aggregates of plural primary particles overall and an uneven shape was markedly formed on the surface of the positive electrode active material.

Further, the crystal phase of this positive electrode active material was measured with an X-ray diffraction apparatus (X′ Pert PRO, manufactured by Panalytical Ltd.), measured by a powder X-ray diffractometry, and was identified by the ICDD card database, the crystal phase of this positive electrode active material was mainly due to the hexagonal layered structure of Li_{1.14}Ni_{0.331}Mn_{0.331}Co_{0.331}Zr_{0.002}W_{0.005}O₂.

[Average Particle Size and Particle Size Distribution]

Using a laser light diffraction scattering type particle size analyzer, the average particle size of this positive electrode active material was measured, and d10 and d90 were also measured to calculate the index of [(d90−d10)/average particle size], which indicates the spread of the particle size distribution. As a result, the average particle size of the positive electrode active material was 5.1 μm, and [(d90−d10)/average particle size] was 0.41.

[Specific Surface Area and Tap Density]

Using this positive electrode active material as a sample, the specific surface area was measured with a flow type gas adsorption method specific surface area measuring apparatus (Multisorb, manufactured by Yuasa Ionics Inc.,), and the tap density was measured with a tapping machine (KRS-406, manufactured by Kuramochi Kagaku) respectively. As a result, the specific surface area of this positive electrode active material was 1.14 m²/g, and the tap density was 1.94 g/cm³.

[Surface Roughness Index]

Using a true density measurement device (AccuPyc1330, manufactured by Micromeritics Ltd.), the true density of this positive electrode active material was measured, and it was 4.66 g/cm³. The surface roughness index of this positive electrode active material was calculated based on the definitions of the formula (1) and the formula (2) by using this true density, said BET specific surface area, and the value of the particle radius of the secondary particles obtained from the average particle size. As a result, the surface roughness index was 4.52.

$$\begin{matrix}[ Equation 1 ] & \\ surface roughness index = \frac{{SSA}_{BET}}{{SSA}_{SPHE}} & ( 1 ) \\ [ Equation 2 ] & \\ {SSA}_{SPHE} = \frac{4 π {r}^{2}}{\frac{4}{3} π {r}^{3} \times {D}_{R}} = \frac{3}{r \times {D}_{R}} & ( 2 )\end{matrix}$$

(In the formula (1), SSA_{BET} means the actually measured specific surface area of the particles measured by the BET method, and SSA_{SPHE} means the geometric surface area when assuming the secondary particles as sphericity, r means the particle radius, and DR means the true density)

e) Production of Secondary Battery

As the premise of producing the 2032-type coin battery (B) as illustrated in FIG. 4, the positive electrode active material that was obtained as described above: 52.5 mg, acetylene black: 15 mg, and PTEE: 7.5 mg were mixed and after press molding with a pressure of 100 MPa so as to be a diameter of 11 mm and a thickness of 100 μm, a positive electrode (1) was produced by drying it at 120° C. for 12 hours in a vacuum dryer.

Then, by using this positive electrode (1), the 2032-type coin battery (B) of an embodiment illustrated in FIG. 4 was produced in a glove box having an argon (Ar) atmosphere with a dew point controlled to −80° C. As for the negative electrode (2) of this 2032-type coin battery (B), lithium metal having a diameter of 17 mm and a thickness of 1 mm was used, and as for the electrolyte, an equal amount mixture (manufactured by Tomiyama Pure Chemical Industries, Ltd.) of ethylene carbonate (EC) having a 1 M of LiClO₄ as supporting electrolyte and diethyl carbonate (DEC) was used. Further, as for the separator (3), a polyethylene porous membrane having a thickness of 25 μm was used. Here, the 2032-type coin battery (B) has a gasket (4), and it is assembled to be a coin-shaped battery with a positive electrode can (5) and a negative electrode can (6).

f) Battery Evaluation

[Initial Discharge Capacity]

After preparing the 2032 type coin battery, the battery was left for about 24 hours, and after the open circuit voltage OCV (Open Circuit Voltage) stabilized, with a current density with respect to the positive electrode of 0.1 mA/cm², the battery was charged to a cutoff voltage of 4.3 V, then after a 1-hour pause, the initial discharge capacity was determined by performing a charge/discharge test to measure the discharge capacity when the battery was discharged until the cut-off voltage reached 3.0 V. As a result, the initial discharge capacity was 159.6 mAh/g. Note that when measuring the initial discharge capacity, a multichannel voltage/current generator (R6741A, manufactured by Advantest Corporation) was used.

[Positive Electrode Resistance]

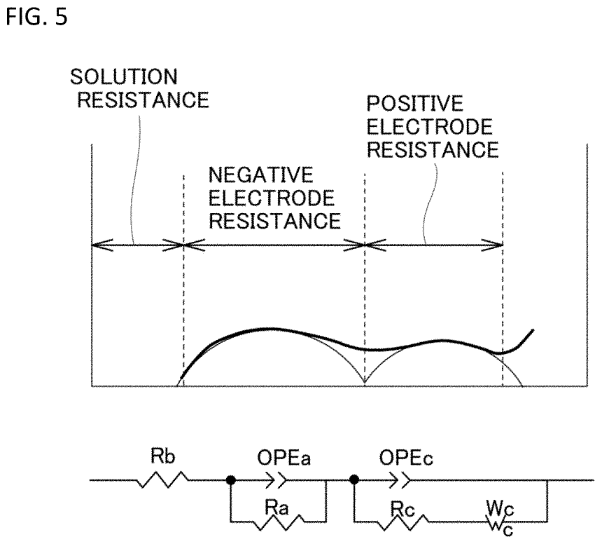

Using a 2032 type coin battery charged at a charging potential of 4.1 V, the resistance value was measured by the AC impedance method. For the measurement, a frequency response analyzer and a potentio-galvanostat (manufactured by Solartron) were used to obtain a Nyquist plot as illustrated in FIG. 5. The plot is expressed as the sum of characteristic curves indicating the solution resistance, the negative electrode resistance and capacity, and the positive electrode resistance and capacity, so a fitting calculation is performed using an equivalent circuit, and the positive electrode resistance value was calculated. As a result, the positive electrode resistance was 1.214Ω.

[Cycle Capacity Retention Rate]

The 200 cycle capacity retention rate was obtained by calculating the ratio of the discharge capacity after repeating a cycle of charging up to 4.2 V and discharging up to 2.5V for 200 times with the current density of 2.0 mA/cm² with respect to the positive electrode. As a result, the cycle capacity retention rate was 85.1%.

The conditions for producing the composite hydroxide and the positive electrode active material, and their characteristics and the characteristics of a battery using them are indicated in Table 1 through Table 4. The following results of Examples 2 through Example 5 and Comparative Example 1 through Comparative Example 4 are also indicated in Table 1 through Table 4.

### Example 2

Except that in the particle growth step, the switching operation 1 was performed 228 minutes (87.5% of the entire time of the particle growth step) from the start of the particle growth step; the switching operation 2 was performed 10 minutes (4.2% of the entire time of the particle growth step) from switching operation 1; after that, the crystallization reaction was continued for 20 minutes (8.3% of the entire time of the particle growth step), others were performed as similar to Example 1 and a composite hydroxide, a positive electrode active material, and a secondary battery were produced and they were evaluated.

### Example 3

Except that in the particle growth step, the switching operation 1 was performed 190 minutes (79.2% of the entire time of the particle growth step) from the start of the particle growth step; the switching operation 2 was performed 30 minutes (12.5% of the entire time of the particle growth step) from switching operation 1; after that, the switching crystallization reaction was continued for 20 minutes (8.3% of the entire time of the particle growth step) from switching operation 2, a composite hydroxide, positive electrode active material and a secondary battery were produced in the same way as in Example 1 and were evaluated.

### Example 4

Except that in the particle growth step, the switching operation 1 was performed 180 minutes (75.0% of the entire time of the particle growth step) from the start of the particle growth step; the switching operation 2 was performed 20 minutes (8.3% of the entire time of the particle growth step) from switching operation 1; after that, the crystallization reaction was continued 40 minutes (16.7% of the entire time of the particle growth step) from switching operation 2, a composite hydroxide, a positive electrode active material, and a secondary battery were produced and evaluated in the same way as in Example 1.

### Example 5

Except that in the particle growth step, the switching operation 1 was performed 210 minutes (87.5% of the entire time of the particle growth step) from the start of the particle growth step; the switching operation 2 was performed 20 minutes (8.3% of the entire time of the particle growth step) from switching operation 1; after that, the crystallization reaction was continued for 10 minutes (4.2% of the entire time of the particle growth step) from the switching operation 2, a composite hydroxide, a positive electrode active material, and a secondary battery were produced and evaluated in the same way as in Example 1.

### Comparative Example 1

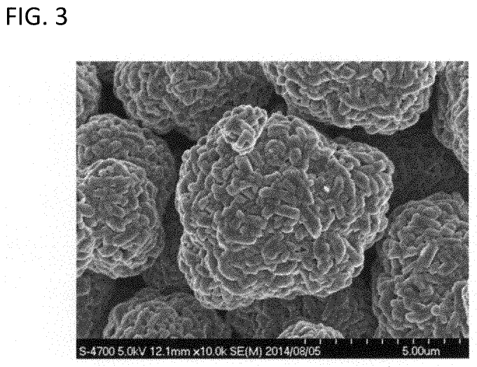

Except that switching of atmosphere was not performed at all in the particle growth step, a composite hydroxide was produced in the same way as in Example 1. The results are indicated in Table 2. Further, except that this composite hydroxide was made to be a precursor, a positive electrode active material and a secondary battery were produced and evaluated in the same way as in Example 1. The results are indicated in Table 3, Table 4, and FIG. 3.

### Comparative Example 2

Except that in the particle growth step, the switching operation 1 was performed 228 minutes (95% of the entire time of the particle growth step) from the start of the particle growth step; the switching operation 2 was performed 1 minute (0.4% of the entire time of the particle growth step) from switching operation 1; after that, the crystallization reaction was continued for 11 minutes (4.6% of the entire time of the particle growth step) from the switching operation 2, a composite hydroxide, positive electrode active material and a secondary battery were produced and evaluated in the same way as in Example 1.

### Comparative Example 3

Except that in the particle growth step, the switching operation 1 was performed 156 minutes (65% of the entire time of the particle growth step) from the start of the particle growth step; the switching operation 2 was performed 72 minutes (30% of the entire time of the particle growth step) from switching operation 1; after that, the crystallization reaction was continued for 12 minutes (5% of the entire time of the particle growth step) from the switching operation 2, a composite hydroxide, positive electrode active material, and a secondary battery were produced and evaluated in the same way as in Example 1.

### Comparative Example 4

Except that in the particle growth step, the switching operation 1 was performed 144 minutes (60% of the entire time of the particle growth step) from the start of the particle growth step; the switching operation 2 was performed 24 minutes (10% of the entire time of the particle growth step) from switching operation 1; after that, the crystallization reaction was continued for 72 minutes (30% of the entire time of the particle growth step) from the switching operation 2, a composite hydroxide, positive electrode active material, and a secondary battery were produced and evaluated in the same way as in Example 1.

TABLE 1

Particle Growth Step

| | | Switching | |
|---|---|---|---|
| | Initiation→ | Operation 1→ | Switching |
| | Switching | Switching | Operation 2→ |
| | Operation 1 | Operatioon2 | Termination |
| | Duration (%) | Duration (%) | Duration (%) |
| Example 1 | 83.4 | 8.3 | 8.3 |
| Example 2 | 87.5 | 4.2 | 8.3 |
| Example 3 | 79.2 | 12.5 | 8.3 |
| Example 4 | 75.0 | 8.3 | 16.7 |
| Example 5 | 87.5 | 8.3 | 4.2 |
| Comparative | 100 | — | — |
| Example 1 | | | |
| Comparative | 95 | 0.4 | 4.6 |
| Example 2 | | | |
| Comparative | 65 | 30 | 5 |
| Example 3 | | | |
| Comparative | 60 | 10 | 30 |
| Example 4 | | | |

TABLE 2

| | Transition metal composite hydroxide | | | | | | |
|---|---|---|---|---|---|---|---|
| | | | | Low- | Outer- | | |
| | | | Main | Density | Shell | | |
| | | Plate- | Portion | Layer | Portion | | |
| | Fine | Shaped | Ratio to | Ratio to | Ratio to | Average | (d90 − d10)/ |
| | Primary | Primary | Particles | Particle | Particle | Particle | Average |
| | Particles | Particles | Size | Size | Size | Size | Particle |
| | (μm) | (μm) | (%) | (%) | (%) | (μm) | Size |
| Example 1 | 0.2 | 0.5 | 82 | 5 | 4 | 5.2 | 0.42 |
| Example 2 | 0.2 | 0.5 | 86 | 3 | 4 | 5.2 | 0.43 |
| Example 3 | 0.3 | 0.6 | 66 | 15 | 2 | 5.4 | 0.41 |
| Example 4 | 0.2 | 0.5 | 68 | 10 | 6 | 5.5 | 0.44 |
| Example 5 | 0.3 | 0.5 | 88 | 4 | 2 | 5.2 | 0.41 |
| Comparative | 0.2 | 0.6 | 100 | 0 | 0 | 5.7 | 0.41 |
| Example 1 | | | | | | | |
| Comparative | 0.2 | 0.6 | 97 | 0.5 | 1 | 5.1 | 0.41 |
| Example 2 | | | | | | | |
| Comparative | 0.2 | 0.6 | 62 | 18 | 1 | 5.5 | 0.43 |
| Example 3 | | | | | | | |
| Comparative | 0.2 | 0.6 | 62 | 8 | 11 | 5.3 | 0.41 |
| Example 4 | | | | | | | |

TABLE 3

| | Positive electrode active material | | | | | |
|---|---|---|---|---|---|---|
| | | | (d90 − d10)/ | BET | | |
| | | Average | Average | Specific | Tap | Surface |
| | Particle | Particle size | Particle | Surface | Density | Roughness |
| | Structure | (μm) | Size | Area (m²/g) | (g/cm³) | Index |
| Example 1 | Solid | 5.1 | 0.41 | 1.14 | 1.94 | 4.52 |
| Example 2 | Solid | 5.1 | 0.41 | 0.96 | 2.01 | 3.80 |
| Example 3 | Solid | 5.2 | 0.40 | 1.31 | 1.65 | 5.29 |
| Example 4 | Solid | 5.3 | 0.42 | 1.02 | 1.88 | 4.20 |
| Example 5 | Solid | 5.0 | 0.39 | 1.18 | 2.03 | 4.58 |
| Comparative | Solid | 5.6 | 0.39 | 0.77 | 2.19 | 3.35 |
| Example 1 | | | | | | |
| Comparative | Solid | 5.2 | 0.41 | 0.88 | 2.10 | 3.55 |
| Example 2 | | | | | | |
| Comparative | Solid | 5.0 | 0.62 | 1.58 | 1.45 | 6.14 |
| Example 3 | | | | | | |
| Comparative | Porous | 5.2 | 0.40 | 1.21 | 1.58 | 4.89 |
| Example 4 | | | | | | |

TABLE 4

| | Initial | Positive | 200 Cycle |
|---|---|---|---|
| | Discharge | Electrode | Capacity |
| | Capacity | Resistance | Retention rate |
| | (mAh/g) | (Ω) | (%) |
| Example 1 | 159.6 | 1.214 | 85.1 |
| Example 2 | 158.8 | 1.424 | 83.3 |
| Example 3 | 158.5 | 1.092 | 85.3 |
| Example 4 | 160.1 | 1.383 | 84.7 |
| Example 5 | 159.2 | 1.147 | 83.8 |
| Comparative | 158.8 | 1.618 | 84.1 |
| Example 1 | | | |
| Comparative | 159.0 | 1.525 | 84.6 |
| Example 2 | | | |
| Comparative | 157.5 | 1.572 | 85.6 |
| Example 3 | | | |
| Comparative | 159.3 | 1.501 | 83.3 |
| Example 4 | | | |

### Example 6

In the particle growth step, the switching operation 1 was performed 195 minutes (80.1% of the entire time of the particle growth step) from the start of the particle growth step; the switching operation 2 was performed 10 minutes (4.2% of the entire time of the particle growth step) from switching operation 1; after that, after 10 minutes (4.2% of the entire time of the particle growth step) from switching operation 2, while continuing the supply of a raw material aqueous solution, by using a ceramic diffusing pipe having a pipe size of 20 μm to 30 μm, air is circulated again in the reaction tank so as to adjust the reaction atmosphere to be an oxidizing atmosphere having an oxygen concentration of 21% by volume (switching operation 3), and after 10 minutes (4.2% of the entire time of the particle growth step) from switching operation 3, while continuing the supply of a raw material aqueous solution, a nitrogen gas is circulated again in the reaction tank so as to adjust the reaction atmosphere to be a non-oxidizing atmosphere having an oxygen concentration of 2% by volume or less (switching operation 4). After that, after 15 minutes (6.3% of the entire time of the particle growth step) from switching operation 4, the supply of all the aqueous solutions was stopped and the particle growth step was terminated. Other than that, a composite hydroxide, a positive electrode active material, and a secondary battery were produced and evaluated in the same way as in Example 1.

The secondary particles forming the obtained composite hydroxide are formed from aggregates of primary particles having a plate-shape as a whole, and it was confirmed that a laminate structure made of the first the low-density layer and the high density layer and the second low-density layer and the outer-shell portion exists near the surface of the secondary particles. The first low-density layer and the second low-density layer existed in the range of 13% from the surface of the secondary particles with respect to the particle size of the secondary particles. The average particle size of the fine primary particles was 0.2 μm, and the average particle size of the plate-shaped primary particles was 0.5 μm. Further, the low-density layer ratio to particle size (the sum of the first and the second low-density layers) was 8%. Measurement and calculation were performed on the main portion ratio to particle size, the first low-density layer ratio to particle size, the high density layer, the second low-density layer ratio to particle size, and the outer-shell portion ratio to particle size, and they were 74%, 4%, 2%, 4% and 3%, respectively.

Further, the average particle size was 5.1 μm, and the value of [(d90−d10)/average particle size] was 0.41.

The obtained positive electrode active material was formed by aggregates of plural primary particles as a whole, and an uneven shape was markedly formed on the surface of the positive electrode active material. The average particle size of the positive electrode active material was 5.2 μm, and the value of [(d90−d10)/average particle size] was 4.3, the specific surface area was 1.16 m²/g, the tap density was 1.93 g/cm³, and the surface roughness index was 4.68.

Further, the initial discharge capacity of the 2032 type coin battery using the obtained positive electrode active material was 159.5 mAh/g, the positive electrode resistance was 1.205Ω, and the 200 cycle capacity retention rate was 85.2%.

### EXPLANATION OF REFERENCE NUMBERS

1 Positive Electrode (Electrode for Evaluation)
2 Negative Electrode
3 Separator
4 Gasket
5 Positive Electrode Can
6 Negative Electrode Can
B 2032 Type Coin Cell
21 Main portion
22 Low-density layer
23 Outer-shell portion

1. A transition metal composite hydroxide comprising secondary particles formed by aggregates of plate-shaped primary particles,
the transition metal composite hydroxide comprising at least one layer of low-density layer formed from aggregates of fine primary particles having a smaller particle size than the plate-shaped primary particles in a range of 30% with respect to the particle size of the secondary particles from the surface of the secondary particles, and the average ratio of the thickness of the at least one layer of low-density layer with respect to the particle size of the secondary particles being within a range of 3% to 15%.

2. The transition metal composite hydroxide according to claim 1, wherein the transition metal composite hydroxide comprises a main portion constructed by the plate-shaped primary particles, a low-density layer formed outside the main portion and constructed by the fine primary particles, and an outer-shell portion formed outside the low-density layer and constructed by the plate-shaped primary particles.

3. The transition metal composite hydroxide according to claim 1, wherein the main portion is constructed by the plate-shaped primary particles; the low-density layer is formed outside the main portion and constructed by the fine primary particles; a high density layer is formed outside the first low-density layer and constructed by the plate-shaped primary particles; a second low-density layer is formed outside the high density layer and constructed by the fine primary particles; and the outer-shell portion is formed outside the second low-density layer and constructed by the plate-shaped primary particles.

4. The transition metal composite hydroxide according to claim 1, wherein the average ratio of the outer diameter of the main portion with respect to the particle size of the secondary particles is within a range of 65% to 95%, and the average ratio of the thickness of the outer-shell portion or the total thickness of the outer-shell portion and the high density layer with respect to the particle size of the secondary particles is within a range of 2% to 15%.

5. The transition metal composite hydroxide according to claim 1, wherein the average particle size of the plate-shaped primary particles is within a range of 0.3 μm to 3 μm, and the average particle size of the fine primary particles is within a range of 0.01 μm to 0.3 μm.

6. The transition metal composite hydroxide according to claim 1, wherein the average particle size of the secondary particles is within a range of 1 μm to 15 μm to, and the value of [(d90−d10)/average particle size], which is an index that represents the spread of the particle size distribution of the secondary particles, is 0.65 or less.

7. The transition metal composite hydroxide according to claim 1, which has a composition that is represented by a general formula (A): NiₓMn_{y}Co_{z}Mₜ (OH)₂₊ₐ, where x+y+z+t=1, 0.3≤x≤0.95, 0.05≤y≤0.55, 0≤z≤0.4, 0≤t≤0.1, 0≤a≤0.5, and M is one or more additional element selected from Mg, Ca, Al, Ti, V, Cr, Zr, Nb, Mo, Hf, Ta, and W.

8. The transition metal composite hydroxide according to claim 7, wherein the additional element M is uniformly distributed inside the transition metal composite hydroxide, and/or a surface of the transition metal composite hydroxide is coated by a compound that includes the additional element M.

9. A method for manufacturing a transition metal composite hydroxide, wherein the method is for manufacturing a transition metal composite hydroxide which is a precursor of the positive electrode active material for a non-aqueous electrolyte secondary battery by mixing a raw material aqueous solution including at least a transition metal element and an aqueous solution including an ammonium ion donor to form a reaction aqueous solution, and performing a crystallization reaction, the method is characterized in comprising:
a nucleation step in which nucleation is performed in a non-oxidizing atmosphere having an oxygen concentration of 5% by volume or less in which the pH value of the reaction aqueous solution at a standard liquid temperature of 25° C. is adjusted to be within a range of 12.0 to 14.0; and
a particle growth step in which at a standard liquid temperature 25° C. the pH value of the reaction aqueous solution including the nuclei obtained in the nucleation step is adjusted to be lower than the pH value of the nucleation step and to be within a range of 10.5 to 12.0 so as to grow the nuclei; wherein
an atmosphere control is performed such that the non-oxidizing atmosphere is maintained in the early period and the middle period of the particle growth step which is in a range of 70% to 90% of time from the initiation of the particle growth step with respect to the entire period of the particle growth step, and in the latter period of the particle growth step, the non-oxidizing atmosphere is switched to the oxidizing atmosphere where the oxygen concentration exceeds 5% by volume, and then the oxidizing atmosphere is switched to the non-oxidizing atmosphere again.

10. The method for manufacturing a transition metal composite hydroxide according to claim 9, wherein in the latter period of the particle growth step, after 0.5% to 20% of time with respect to the entire particle growth step passed from the point of switching the non-oxidizing atmosphere to the oxidizing atmosphere, the oxidizing atmosphere is switched to the non-oxidizing atmosphere again, and maintain the non-oxidizing atmosphere from the point of switching the atmosphere again to the termination of the particle growth step, that is for a range of 3% to 20% of time with respect to the entire particle growth step.

11. The method for manufacturing a transition metal composite hydroxide according to claim 9, wherein the transition metal composite hydroxide has a composition that is represented by a general formula (A): NiₓMn_{y}Co_{z}Mₜ (OH)₂₊ₐ, where x+y+z+t=1, 0.3≤x≤0.95, 0.05≤y≤0.55, 0≤z≤0.4, 0≤t≤0.1, 0≤a≤0.5, and M is one or more additional element selected from Mg, Ca, Al, Ti, V Cr, Zr, Nb, Mo, Hf, Ta, and W.

12. The method for manufacturing a transition metal composite hydroxide according to claim 11, wherein after the particle growth step, a coating step may be further provided for coating the surface of the transition metal composite hydroxide with a compound that includes the additional element M.

13. A positive electrode active material for a non-aqueous electrolyte secondary battery which includes secondary particles formed by aggregates of a plurality of primary particles and having a tap density of 1.5 g/cm³ or more and a surface roughness index which is a value in which the measured specific surface area of the secondary particles is divided by the geometric surface area of the secondary particles when the secondary particles are assumed to be true sphere is within a range of 3.6 to 10.

14. The positive electrode active material for a non-aqueous electrolyte secondary battery according to claim 13, wherein the average particle size of the secondary particles is within a range of 1 μm to 15 μm, and the value of [(d90−d10)/average particle size], which is an index indicating the spread of the particle size distribution of the secondary particles, is 0.7 or less.

15. The positive electrode active material for a non-aqueous electrolyte secondary battery according to claim 13, which is constructed by a hexagonal lithium nickel manganese composite oxide represented by a general formula (B): Li₁₊ᵤNiₓMn_{y}Co_{z}MₜO₂, where −0.05≤u≤0.50, x+y+z+t=1, 0.3≤x≤0.95, 0.05≤y≤0.55, 0≤z≤0.4, 0≤t≤0.1, and M is one or more additional element selected from Mg, Ca, Al, Ti, V, Cr, Zr, Nb, Mo, Hf, Ta, and W.

16. A method for manufacturing a positive electrode active material for a non-aqueous electrolyte secondary battery comprising:
a mixing step to form a lithium mixture by mixing heat-treated particles obtained by heat-treating the transition metal composite hydroxide or the transition metal composite hydroxide according to claim 1 and a lithium compound; and
a firing step in which the lithium mixture is fired at a temperature range of 650° C. to 1000° C. to obtain a positive electrode active material for a non-aqueous electrolyte secondary battery that is constructed by a lithium transition metal-containing composite oxide.

17. The method for manufacturing a positive electrode active material for a non-aqueous electrolyte secondary battery according to claim 16, wherein in the mixing step, the mixing amount of the lithium compound is preferably adjusted so that the ratio of the number of atoms of Li that is included in the lithium mixture with respect to the sum of the number of atoms of metal elements other than Li is within a range of 0.95 to 1.5.

18. The method for manufacturing a positive electrode active material for a non-aqueous electrolyte secondary battery according to claim 16, which comprises a heat-treating step to heat-treat the transition metal composite hydroxide at a temperature range of 105° C. to 750° C. before the mixing step.

19. The method for manufacturing a positive electrode active material for a non-aqueous electrolyte secondary battery according to claim 16, wherein the lithium transition metal-containing composite oxide has a composition represented by a general formula (B): Li₁₊ᵤNiₓMn_{y}Co_{z}MₜO₂, where −0.05≤u≤0.50, x+y+z+t=1, 0.3≤x≤0.95, 0.05≤y≤0.55, 0≤z≤0.4, 0≤t≤0.1, and M is one or more additional element selected from Mg, Ca, Al, Ti, V, Cr, Zr, Nb, Mo, Hf, Ta, and w).

20. A non-aqueous electrolyte secondary battery comprising a positive electrode, a negative electrode, a separator, and a non-aqueous electrolyte, and the positive electrode active material for a non-aqueous electrolyte secondary battery according to claim 13 is used as the positive electrode material of the positive electrode.
